(19) United States
(12) Patent Application Publication
(10) Pub. No.: US 2026/0320828 A1
(43) Pub. Date: Oct. 15, 2026

(54) METHOD AND APPARATUS OF PROCESSING IMAGE, INTERACTIVE DEVICE, ELECTRONIC DEVICE, AND STORAGE MEDIUM

(71) Applicant: BOE TECHNOLOGY GROUP CO., LTD., Beijing (CN)

(72) Inventors: Siyan MA, Beijing (CN); Hao ZHANG, Beijing (CN); Xinkai LI, Beijing (CN); Yaoyu LV, Beijing (CN); Yan LI, Beijing (CN)

(21) Appl. No.: 19/706,959

(22) Filed: Jun. 12, 2026

Related U.S. Application Data
(63) Continuation-in-part of application No. 18/553,155, filed on Dec. 1, 2022.

(51) Int. Cl. G06T 7/73

(52) U.S. Cl. CPC G06T 7/75; G06T 2207/30201

(57) ABSTRACT

A method and an apparatus of processing an image, an interactive device, an electronic device, a storage medium, and a computer program product are provided. The method of processing the image includes: acquiring N1 two-dimensional key points from a face image of an object, wherein a plurality of facial regions in the face image respectively correspond to a plurality of mapping models; mapping the N1 two-dimensional key points into N2 two-dimensional key points by mapping the two-dimensional key points within each facial region based on the mapping model corresponding to the facial region, where N2 is not equal to N1; performing an iterative optimization on an initial three-dimensional face template by using the N2 two-dimensional key points to obtain a target three-dimensional face template; and determining a head pose of the object according to a corresponding relationship between the face image and the target three-dimensional face template.

### CROSS-REFERENCE TO RELATED APPLICATIONS

This application is a continuation-in-part application of application Ser. No. 18/553,155 filed on Sep. 28, 2023, which is a Section 371 National Stage Application of International Application No. PCT/CN2022/135733, filed on Dec. 1, 2022, entitled “METHOD AND APPARATUS OF PROCESSING IMAGE, INTERACTIVE DEVICE, ELECTRONIC DEVICE, AND STORAGE MEDIUM”, the content of which is hereby incorporated by reference in its entirety.

### TECHNICAL FIELD

The present disclosure relates to a field of image processing technology, in particular to a method and an apparatus of processing an image, an interactive device, an electronic device, a storage medium, and a computer program product.

### BACKGROUND

Augmented Reality (AR) devices, Virtual Reality (VR) devices and three-dimensional (3D) screen interactive devices generally need to acquire a relative face pose of a user in real time and adjust a display effect according to the relative face pose, so as to provide the user with a more realistic experience. For example, a glasses-free 3D screen may adjust opening and closing of an internal grating of the screen according to a real-time pose of face, head or pupils of the user, so that an optimal glasses-free 3D viewing effect may be presented to the user in a current viewing pose.

At present, a traditional pose estimation algorithm is implemented to perform a pose estimation based on a rigid object and a fixed template. However, a face image is a typical non-rigid object, and each face image has individual differences. AR devices, VR devices or 3D screen interactive devices are applicable to a wide range of users, and it is difficult to obtain accurate face pose estimation results for different users by using the traditional pose estimation algorithms.

### SUMMARY

The present disclosure provides a method and an apparatus of processing an image, an interactive device, an electronic device, a storage medium, and a computer program product.

According to an aspect, the present disclosure provides a method of processing an image, including: constructing an initial three-dimensional face template by using a plurality of sample face images; performing an iterative optimization on the initial three-dimensional face template by using a face image of a target object, so as to obtain a target three-dimensional face template; and determining a current face pose of the target object according to a corresponding relationship between a current face image of the target object and the target three-dimensional face template.

For example, the constructing an initial three-dimensional face template by using a plurality of sample face images includes: acquiring a plurality of three-dimensional sample key points from each of the plurality of sample face images; determining an average three-dimensional face template according to a plurality of three-dimensional sample key points of the plurality of sample face images; determining a feature matrix of the plurality of sample face images by using the average three-dimensional face template; and constructing the initial three-dimensional face template according to an iteration parameter, the average three-dimensional face template and the feature matrix.

For example, the determining a feature matrix of the plurality of sample face images by using the average three-dimensional face template includes: performing a decentralization on the plurality of three-dimensional sample key points of the plurality of sample face images by using the average three-dimensional face template, so as to obtain a covariance matrix; calculating a plurality of feature values of the covariance matrix and a plurality of feature vectors corresponding to the plurality of feature values; determining a plurality of valid feature vectors from the plurality of feature vectors according to contribution values of the plurality of feature values to a linear projection in the covariance matrix, where a sum of the contribution values of a plurality of feature values corresponding to the plurality of valid feature vectors is greater than a predetermined contribution value; and constructing the feature matrix according to the plurality of valid feature vectors.

For example, the performing an iterative optimization on the initial three-dimensional face template by using a face image of a target object so as to obtain a target three-dimensional face template includes: acquiring a plurality of two-dimensional target key points from the face image of the target object; determining a plurality of three-dimensional key points from the initial three-dimensional face template; projecting the plurality of three-dimensional key points into a plurality of two-dimensional projection key points; calculating an average error between the plurality of two-dimensional projection key points and the plurality of two-dimensional target key points; and performing the iterative optimization on the initial three-dimensional face template according to the average error, so as to obtain the target three-dimensional face template.

For example, the projecting the plurality of three-dimensional key points into a plurality of two-dimensional projection key points includes: constructing a weak perspective projection model according to coordinate values of the three-dimensional key points, a scaling ratio, a coordinate system rotation matrix, and a center point offset vector of a pixel coordinate system; and projecting the plurality of three-dimensional key points into a plurality of two-dimensional projection key points by using the weak perspective projection model.

For example, the weak perspective projection model is configured to project the plurality of three-dimensional key points into a plurality of two-dimensional projection key points according to:

$$[ \begin{matrix}x \\ y\end{matrix} ] = scale \cdot [ \begin{matrix}{R}_{00} & {R}_{01} & {R}_{02} \\ {R}_{10} & {R}_{11} & {R}_{21}\end{matrix} ] \cdot [ \begin{matrix}X \\ Y \\ Z\end{matrix} ] + [ \begin{matrix}{t}_{x} \\ {t}_{y}\end{matrix} ]$$

where x and y respectively represent coordinate values of the two-dimensional projection key points on x-axis and y-axis of the pixel coordinate system, X, Y and Z respectively represent coordinate values of the three-dimensional key points on x-axis, y-axis and z-axis of a coordinate system where the target object is located, scale represents the scaling ratio,

$$[ \begin{matrix}{R}_{00} & {R}_{01} & {R}_{02} \\ {R}_{10} & {R}_{11} & {R}_{21}\end{matrix} ]$$

represents a rotation matrix of the coordinate system where the target object is located with respect to a camera coordinate system, and tₓ and t_{y} respectively represent offset vectors of an origin of the pixel coordinate system with respect to an origin of the camera coordinate system on x-axis and y-axis.

For example, the performing the iterative optimization on the initial three-dimensional face template according to the average error so as to obtain the target three-dimensional face template includes: constructing an iteration model according to the weak perspective projection model and the iteration parameter; determining a mapping function between the iteration model and the plurality of two-dimensional projection key points; calculating a Jacobi matrix of the mapping function to obtain iteratively-optimized two-dimensional iterative key points; calculating an average error according to the two-dimensional iterative key points and the plurality of two-dimensional target key points from the face image; updating a parameter of the iteration model in a descent gradient direction of the Jacobi matrix to obtain an updated iteration model, and returning to an operation of determining the mapping function between the iteration model and the plurality of two-dimensional projection key points, in response to a determination that the average error does not meet a convergence condition; and determining the iteration parameter and constructing the target three-dimensional face template according to the iteration parameter, in response to a determination that the average error meets the convergence condition.

For example, the mapping function includes:

$$F ( [ \begin{matrix}scale \\ {R}_{x} \\ {R}_{y} \\ {R}_{z} \\ {t}_{x} \\ {t}_{y} \\ params\end{matrix} ] ) = [ \begin{matrix}current\_shape \_ 2 D\_x \\ current\_shape \_ 2 D\_y\end{matrix} ]$$

where

$$[ \begin{matrix}current\_shape \_ 2 D\_x \\ current\_shape \_ 2 D\_y\end{matrix} ]$$

represents a coordinate value matrix of the plurality of two-dimensional projection key points,

$$F ( [ \begin{matrix}scale \\ {R}_{x} \\ {R}_{y} \\ {R}_{z} \\ {t}_{x} \\ {t}_{y} \\ params\end{matrix} ] )$$

represents the iteration model, scale represents the scaling ratio, Rₓ, R_{y} and R_{z} represent rotation amounts of the coordinate system where the target object is located with respect to the camera coordinate system, tₓ and t_{y} respectively represent offset vectors of an origin of the pixel coordinate system with respect to an origin of the camera coordinate system on x-axis and y-axis, and params represents the iteration parameter.

For example, the updating a parameter of the iteration model in a descent gradient direction of the Jacobi matrix to obtain an updated iteration model includes: calculating a parameter variation of the iteration model according to the descent gradient direction of the Jacobi matrix and the average error; and updating the parameter of the iteration model according to the parameter variation, so as to obtain the updated iteration model.

For example, the updating the parameter of the iteration model according to the parameter variation so as to obtain the updated iteration model includes updating the iteration model according to:

$$[ \begin{matrix}{scale}^{′} \\ {{R}_{x}}^{′} \\ {{R}_{y}}^{′} \\ {{R}_{z}}^{′} \\ {{t}_{x}}^{′} \\ {{t}_{y}}^{′} \\ {params}^{′}\end{matrix} ] = [ \begin{matrix}scale \\ {R}_{x} \\ {R}_{y} \\ {R}_{z} \\ {t}_{x} \\ {t}_{y} \\ params\end{matrix} ] - delta$$

where

$$[ \begin{matrix}{scale}^{′} \\ {{R}_{x}}^{′} \\ {{R}_{y}}^{′} \\ {{R}_{z}}^{′} \\ {{t}_{x}}^{′} \\ {{t}_{y}}^{′} \\ {params}^{′}\end{matrix} ]$$

represents the updated iteration model,

$$[ \begin{matrix}scale \\ {R}_{x} \\ {R}_{y} \\ {R}_{z} \\ {t}_{x} \\ {t}_{y} \\ params\end{matrix} ]$$

represents an un-updated iteration model, and delta represents the parameter variation.

For example, the calculating an average error between the plurality of two-dimensional projection key points and the plurality of two-dimensional target key points includes: calculating a re-projection error according to the plurality of two-dimensional projection key points and the plurality of two-dimensional target key points; and calculating the average error according to the re-projection error.

For example, the calculating the average error according to the re-projection error includes calculating the average error according to:

$$error = \frac{1}{68} {\sum }_{i = 0}^{67} {‖ {proj}_{err} ‖}^{2}$$

where error represents the average error, projₑᵣᵣ represents the re-projection error, projₑᵣᵣ=landmarks_{2D}−currentₛₕₐₚₑ_{_{2D}}, landmarks_{2D} represents the coordinate values of the two-dimensional target key points, and currentₛₕₐₚₑ_{_{2D}} represents the coordinate values of the two-dimensional projection key points.

For example, the determining a current face pose of the target object according to a corresponding relationship between a current face image of the target object and the target three-dimensional face template includes: determining a plurality of predetermined three-dimensional key points of the target object from a plurality of three-dimensional key points of the target three-dimensional face template, where the plurality of predetermined three-dimensional key points are located in a target coordinate system, and the plurality of predetermined three-dimensional key points correspond to a plurality of specified two-dimensional key points of the current face image of the target object; determining a transformation matrix between the camera coordinate system and the target coordinate system according to a corresponding relationship between the pixel coordinate system where the face image from a camera is located and the target coordinate system; converting the plurality of predetermined three-dimensional key points into a plurality of target three-dimensional key points according to the transformation matrix, where the plurality of target three-dimensional key points are located in the camera coordinate system; and determining the current face pose of the target object according to the plurality of target three-dimensional key points.

For example, the determining a transformation matrix between the camera coordinate system and the target coordinate system according to a corresponding relationship between the pixel coordinate system where the face image from a camera is located and the target coordinate system includes determining the transformation matrix according to:

$$c [ \begin{matrix}x \\ y \\ 1\end{matrix} ] = K \cdot [ \begin{matrix}R & t \\ 0 & 1\end{matrix} ] \cdot [ \begin{matrix}X \\ Y \\ Z \\ 1\end{matrix} ]$$

where c represents a scale of the camera, x and y respectively represent coordinate values of the two-dimensional projection key points on x-axis and y-axis of the pixel coordinate system, X, Y and Z respectively represent coordinate values of the predetermined three-dimensional key points on x-axis, y-axis and z-axis of the target coordinate system, K represents an internal parameter matrix of the camera, and

$$[ \begin{matrix}R & t \\ 0 & 1\end{matrix} ]$$

represents the transformation matrix.

For example, the acquiring a plurality of two-dimensional target key points from the face image of the target object includes: performing a distortion correction on the face image to obtain a corrected face image; and determining the plurality of two-dimensional target key points from the corrected face image by using a key point detection algorithm.

For example, the performing a distortion correction on the face image to obtain a corrected face image includes performing the distortion correction on the face image according to:

$$\{ \begin{matrix}{x}_{0} = x ( 1 + {k}_{1} {r}^{2} + {k}_{2} {r}^{4} + {k}_{3} {r}^{6} ) \\ {y}_{0} = y ( 1 + {k}_{1} {r}^{2} + {k}_{2} {r}^{4} + {k}_{3} {r}^{6} ) \\ {x}_{0} = x + [ 2 {p}_{1} xy + {p}_{2} ( {r}^{2} + 2 {x}^{2} ) ] \\ {x}_{0} = x + [ 2 {p}_{1} xy + {p}_{2} ( {r}^{2} + 2 {x}^{2} ) ]\end{matrix}$$

where x₀ and y₀ respectively represent coordinate values of a coordinate point on the face image on x-axis and y-axis, x and y respectively represent coordinate values of a coordinate point on the corrected face image on x-axis and y-axis, r represents a distance between a center point of the face image and the coordinate point (x, y), k₁, k₂ and k₃ are radial distortion coefficients, and p₁ and p₂ are tangential distortion coefficients.

According to another aspect, the present disclosure provides an apparatus of processing an image, including: a construction module configured to construct an initial three-dimensional face template by using a plurality of sample face images; an iteration module configured to perform an iterative optimization on the initial three-dimensional face template by using a face image of a target object, so as to obtain a target three-dimensional face template; and a determination module configured to determine a current face pose of the target object according to a corresponding relationship between a current face image of the target object and the target three-dimensional face template.

According to another aspect, the present disclosure provides an interactive device, including: a camera configured to acquire a face image of a target object; a processor electrically connected to the camera, where the processor is configured to: perform an iterative optimization on an initial three-dimensional face template by using the face image so as to obtain a target three-dimensional face template; perform a face pose estimation by using the target three-dimensional face template so as to obtain pupil coordinates of the target object; and calculate a grating opening and closing sequence according to the pupil coordinates; a driving circuit electrically connected to the processor, where the driving circuit is configured to control an output interface to output the grating opening and closing sequence; and a screen electrically connected to the driving circuit, where the screen is configured to control opening and closing of a grating in the screen according to the grating opening and closing sequence.

According to another aspect, the present disclosure provides a method of processing an image, including: acquiring N1 two-dimensional key points from a face image of an object, where the face image includes a plurality of facial regions, and the plurality of facial regions respectively correspond to a plurality of mapping models; mapping the N1 two-dimensional key points of the face image into N2 two-dimensional key points by mapping the two-dimensional key points within each facial region based on the mapping model corresponding to the facial region, where N2 is not equal to N1; performing an iterative optimization on an initial three-dimensional face template by using the N2 two-dimensional key points of the face image, so as to obtain a target three-dimensional face template; and determining a head pose of the object according to a corresponding relationship between the face image and the target three-dimensional face template.

According to another aspect, the present disclosure provides an interactive device, including: a camera configured to acquire a face image of an object; a processor electrically connected to the camera, where the processor is configured to: acquire N1 two-dimensional key points from a face image of an object, where the face image includes a plurality of facial regions, and the plurality of facial regions respectively correspond to a plurality of mapping models; map the N1 two-dimensional key points of the face image into N2 two-dimensional key points by mapping the two-dimensional key points within each facial region based on the mapping model corresponding to the facial region, where N2 is not equal to N1; perform an iterative optimization on an initial three-dimensional face template by using the N2 two-dimensional key points of the face image, so as to obtain a target three-dimensional face template; perform a face pose estimation by using the target three-dimensional face template so as to obtain pupil coordinates of the object; and calculate a grating opening and closing sequence according to the pupil coordinates; a driving circuit electrically connected to the processor, where the driving circuit is configured to control an output interface to output the grating opening and closing sequence; and a screen electrically connected to the driving circuit, where the screen is configured to control opening and closing of a grating in the screen according to the grating opening and closing sequence.

According to another aspect, the present disclosure provides an electronic device, including: one or more processors; and a memory configured to store one or more programs, where the one or more programs, when executed by the one or more processors, are configured to cause the one or more processors to implement the method described in the embodiments of the present disclosure.

According to another aspect, the present disclosure provides a computer-readable storage medium having executable instructions therein, and the instructions, when executed by a processor, are configured to cause the processor to implement the method described in the embodiments of the present disclosure.

According to another aspect, the present disclosure provides a computer program product containing a computer program, and the computer program, when executed by a processor, is configured to implement the method described in the embodiments of the present disclosure.

### BRIEF DESCRIPTION OF THE DRAWINGS

FIG. 1 shows a flowchart of a method of processing an image according to the embodiments of the present disclosure;

FIG. 2A shows an application scenario diagram of the method of processing the image according to the embodiments of the present disclosure;

FIG. 2B shows a flowchart diagram of the method of processing the image according to the embodiments of the present disclosure;

FIG. 2C shows a schematic diagram of an example of a distribution of key points in a face image according to the embodiments of the present disclosure;

FIG. 3 shows a flowchart of constructing an initial three-dimensional face template according to the embodiments of the present disclosure;

FIG. 4 shows a flowchart of iterating the initial three-dimensional face template according to the embodiments of the present disclosure;

FIG. 5 shows a flowchart of iterating the initial three-dimensional face template according to other embodiments of the present disclosure;

FIG. 6A shows a flowchart of determining a face pose of a target object according to the embodiments of the present disclosure;

FIG. 6B shows a schematic diagram of a transformation from a target coordinate system to a camera coordinate system according to the embodiments of the present disclosure;

FIG. 7 shows a schematic diagram of another example of a distribution of key points in a face image according to the embodiments of the present disclosure;

FIG. 8 shows a flowchart of a method of processing an image according to other embodiments of the present disclosure;

FIG. 9 shows a flowchart of a method of processing an image according to other embodiments of the present disclosure;

FIG. 10 shows a flowchart of a method for constructing a deviation field according to the embodiments of the present disclosure;

FIG. 11A shows a schematic diagram of a screen coordinate system according to the embodiments of the present disclosure;

FIGS. 11B to 11F show schematic diagrams of a construction and usage of a deviation field in a z-axis direction;

FIGS. 12A to 12D show schematic diagrams of a construction and usage of a deviation field in a x-axis direction;

FIG. 13 shows a structural block diagram of an apparatus of processing an image according to the embodiments of the present disclosure;

FIG. 14 shows a block diagram of an electronic device suitable for implementing a method of processing an image according to the embodiments of the present disclosure; and

FIG. 15 shows a schematic diagram of an application of pose detection in control scenarios according to the embodiments of the present disclosure.

### DETAILED DESCRIPTION OF EMBODIMENTS

In order to make objectives, technical solutions and advantages of the present disclosure clearer, the technical solutions in the embodiments of present disclosure are clearly and completely described below with reference to the drawings in the embodiments of the present disclosure. Obviously, the described embodiments are only a part but not all of the embodiments of the present disclosure. Based on the described embodiments of the present disclosure, all additional embodiments obtained by those ordinary skilled in the art without carrying out inventive effort fall within the protection scope of the present disclosure. It should be noted that throughout the drawings, the same elements are represented by the same or similar reference numerals. In the following descriptions, some specific embodiments are only used for descriptive purposes and should not be construed as limiting the present disclosure, but rather examples of the embodiments of the present disclosure. When it is possible to cause confusions in the understanding of the present disclosure, conventional structures or configurations will be omitted. It should be noted that the shape and size of each component in the figures do not reflect the actual size and ratio, but just illustrate the contents of the embodiments of the present disclosure.

Unless otherwise defined, the technical or scientific terms used in the embodiments of the present disclosure should have the usual meanings understood by those skilled in the art. The words “first,” “second,” and the like used in the embodiments of the present disclosure do not indicate any order, quantity or importance, but are just used to distinguish different composition parts.

In technical solutions of the present disclosure, a collection, a storage, a use, a processing, a transmission, a provision, a disclosure, an application and other processing of user personal information involved comply with provisions of relevant laws and regulations, take necessary security measures, and do not violate public order and good custom.

In the technical solutions of the present disclosure, the acquisition or collection of user personal information has been authorized or allowed by users.

Various embodiments according to the present disclosure will be described in detail below with reference to the accompanying drawings. It should be noted that in the accompanying drawings, the same reference numerals are assigned to composition parts that have substantially the same or similar structures and functions, and repeated descriptions about them will be omitted.

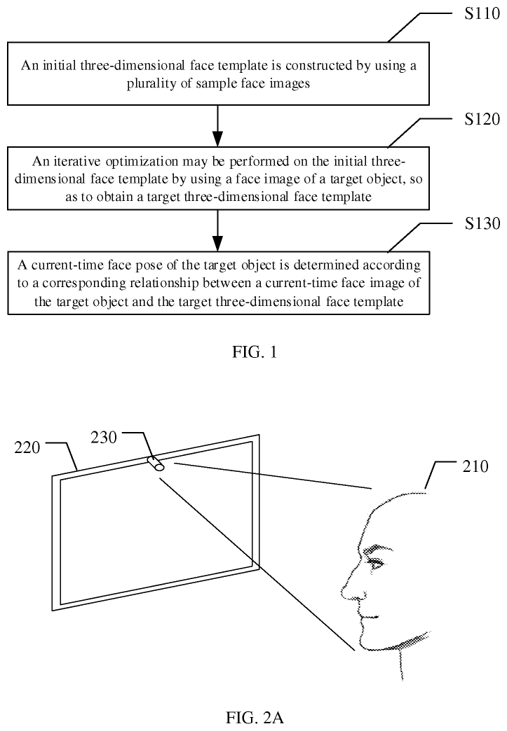

FIG. 1 shows a flowchart of a method of processing an image according to the embodiments of the present disclosure.

As shown in FIG. 1, the method of processing the image according to the embodiments of the present disclosure may include step S110 to step S130 as follows. It should be noted that the sequence number of each step in the following method is just used to indicate the step for ease of description, and should not be regarded as indicating the execution order of the steps. Unless explicitly stated, the method does not need to be performed exactly in the order shown.

In step S110, an initial three-dimensional face template is constructed by using a plurality of sample face images.

For example, the plurality of sample face images may be pre-collected face images of a plurality of users. For example, the plurality of sample face images may be sourced from an open-source Large Scale 3D Faces in-the-Wild (LS3D-W) dataset. The plurality of sample face images may include two-dimensional face images and three-dimensional face images. Two-dimensional coordinate points and three-dimensional coordinate points on the sample face images may be acquired from the plurality of sample face images.

In the embodiments of the present disclosure, the initial three-dimensional face template may be constructed according to a plurality of two-dimensional coordinate points and three-dimensional coordinate points from a plurality of sample face data. The initial three-dimensional face template may be a general three-dimensional face template used to indicate an average feature of face images.

In step S120, an iterative optimization may be performed on the initial three-dimensional face template by using a face image of a target object, so as to obtain a target three-dimensional face template.

For example, the target object may be a user using a head-mounted display device (such as AR or VR) or 3D screen interactive device. A camera is installed on the head-mounted display device or 3D screen interactive device. When being allowed or authorized by the user, the head-mounted display device or 3D screen interactive device captures a face image of the user through the camera. For example, the camera may be a depth sensor (depth camera), a binocular camera, a monocular camera, LiDAR, and so on.

For example, a face image of the user may be captured by a monocular camera, and the face image is a two-dimensional face image. The two-dimensional face image may describe a facial feature belonging to the user. By performing an iterative optimization on the initial three-dimensional face template using the facial feature from the two-dimensional face image, it is possible to obtain a target three-dimensional face template that may indicate the facial feature of the user.

In step S130, a current face pose of the target object is determined according to a corresponding relationship between a current face image of the target object and the target three-dimensional face template.

For example, the current face image of the target object may be a two-dimensional face image captured by the camera at current time instant. A current facial position of the target object may be estimated according to a corresponding relationship between the two-dimensional face image and a same part in the target three-dimensional face template. For example, according to an image information about a pupil part of the target object in the current face image of the target object, a pose of the corresponding pupil part is estimated in the target three-dimensional face template.

A face pose determined in the target three-dimensional face template is a face pose in a target coordinate system where the user is located. The head-mounted display device or 3D screen interactive device may perform a face pose estimation on the user by using the target face template and determine a face pose in a camera coordinate system where the camera is located.

For example, the head-mounted display device or 3D screen interactive device may determine a current face pose of the user, such as an information of facial orientation and facial expression, according to the face pose data in the camera coordinate system, and provide an interactive service for the user based on the current face pose of the user.

For example, the head-mounted display device or 3D screen interactive device may perform a face pose estimation by using the target face template through a pose estimation algorithm. For example, the pose estimation algorithm may include point cloud-based 3D object detection, point cloud-based template matching, and single image-based Perspective-n-Points (PNP) pose estimation algorithm.

For example, a real-time pose of pupils in the face may be determined in the face pose in the camera coordinate system. The 3D screen interactive device may adjust opening and closing of internal gratings of the screen according to the real-time pose of the pupils, and provide the user with an optimal glasses-free 3D viewing effect in the current viewing pose.

According to the embodiments of the present disclosure, an iterative optimization may be performed on the initial three-dimensional face template by using a real-time face image of the user, so as to obtain the target three-dimensional face template that may indicate the current face pose feature of the feature. By using the target three-dimensional face template, it is possible to accurately determine the current face pose of the user, reduce an error of the face pose, and provide a better 3D visual effect for the user.

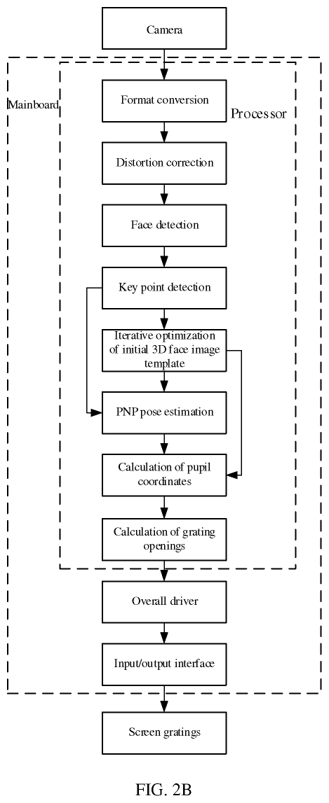

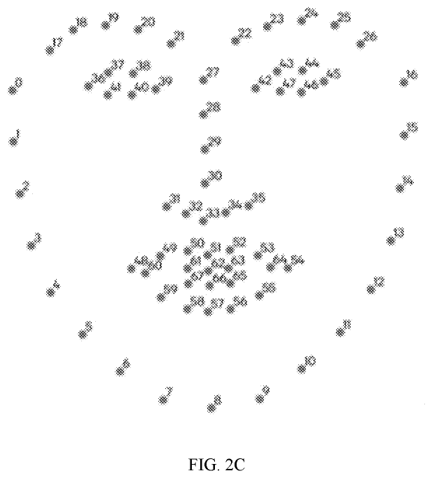

FIG. 2A shows an application scenario diagram of the method of processing the image according to the embodiments of the present disclosure. FIG. 2B shows a flowchart diagram of the method of processing the image according to the embodiments of the present disclosure. FIG. 2C shows a schematic diagram of a distribution of key points in a face image according to the embodiments of the present disclosure.

As shown in FIG. 2A, when a 3D screen interactive device 220 is viewed by a user 210, a camera 230 installed on the 3D screen interactive device 220 captures a face image of the user 210. The face image captured by the camera 230 is a two-dimensional face image. The camera 230 sends the two-dimensional face image to the 3D screen interactive device 230, and the 3D interactive device 220 performs an iterative optimization on an initial three-dimensional face model according to the two-dimensional face image, so as to obtain a target three-dimensional face template corresponding to the user 210. The 3D screen interactive device 220 performs a face pose estimation on the user 210 by using the target three-dimensional face template to obtain a three-dimensional face pose in a camera coordinate system, and provides a 3D visual service for the user 210 according to the three-dimensional face pose.

Referring to FIG. 2B, FIG. 2B shows a schematic diagram of, for example, the 3D screen interactive device 220 processing an image.

As shown in FIG. 2B, the 3D screen interactive device 220 acquires the two-dimensional face image of the user from the camera 210, and the two-dimensional face image is processed by a mainboard of the 3D screen interactive device 220 to obtain a three-dimensional face pose in the camera coordinate system. A control signal is sent to a screen grating based on the three-dimensional face pose in the camera coordinate system, so as to control the opening and closing of the screen grating.

For example, the mainboard may include an Access Point (AP) mainboard, and the processing operations are performed by a processor CPU on the mainboard.

For example, a format of the two-dimensional face image from the camera may be converted by the CPU from an NV21 format image to a Mat format image. The CPU performs a distortion correction on the Mat format image to obtain a corrected face image, and then determines a plurality of two-dimensional target key points from the corrected face image by using a key point detection algorithm.

A calculation principle of the pose estimation algorithm is based on an ideal camera model, and a pose estimation is performed in a camera model without distortion. Typically, a camera may have a tangential distortion caused by lens not being completely parallel to an image screen, and a radial distortion caused by light bending.

The present disclosure provides a method of correcting an image distortion.

For example, a distortion correction may be performed on the face image according to Equation (1).

$$\{ \begin{matrix}{x}_{0} = x ( 1 + {k}_{1} {r}^{2} + {k}_{2} {r}^{4} + {k}_{3} {r}^{6} ) \\ {y}_{0} = y ( 1 + {k}_{1} {r}^{2} + {k}_{2} {r}^{4} + {k}_{3} {r}^{6} ) \\ {x}_{0} = x + [ 2 {p}_{1} xy + {p}_{2} ( {r}^{2} + 2 {x}^{2} ) ] \\ {x}_{0} = x + [ 2 {p}_{1} xy + {p}_{2} ( {r}^{2} + 2 {x}^{2} ) ]\end{matrix} \qquad ( 1 )$$

x₀ and y₀ respectively represent coordinate values of any coordinate point on an uncorrected face image on x-axis and y-axis of a pixel coordinate system, and x and y respectively represent coordinate values of any coordinate point on the corrected face image on x-axis and y-axis of the pixel coordinate system. The pixel coordinate system is a coordinate system where the two-dimensional face image captured by the camera is located.

r represents a distance between a center point of the face image and the coordinate point (x, y), r²=x²+y². The further away the point is from the center point on the face image, the greater the distortion of the point.

k₁, k₂ and k₃ are radial distortion coefficients, and p₁ and p₂ are tangential distortion coefficients. For example, k₁, k₂, k₃, p₁ and p₂ are fixed parameters of the camera. Those skilled in the art may acquire the fixed parameters of the camera by any means in the art.

When determining the two-dimensional target key points, the CPU needs to first perform a face detection on the Mat format image to determine a facial region in the Mat format image, and then perform a key point detection on an image in the facial region through a facial key point detection algorithm, so as to obtain a plurality of two-dimensional target key points.

The two-dimensional target key points may include 5 key points, 21 key points, 49 key points, or 68 key points. According to actual detection needs, other numbers of key points may also be selected, such as tens of thousands of key points. For example, the key points may be distributed at eyes, nose tip, left and right corners of mouth, eyebrows and other regions. The plurality of key points need to be distributed on a plurality of planes, so that the key points may describe the facial feature more accurately.

For example, with more key points, an accuracy of a result of pose estimation solving may be improved, but a detection and solving time may also be increased. In the embodiments of the present disclosure, 68 facial key points are used, which may simultaneously ensure the real-time and accuracy requirements of the algorithm. A distribution and order of the 68 facial key points are shown in FIG. 2C.

For example, the face detection algorithm and the key point detection algorithm may be implemented using CascadeClassifier class and Facemark class in OpenCV library. CascadeClassifier may perform a key point detection based on cascaded classifiers for Haar, LBP, HOG and other features. Facemark may perform a key point detection based on local binary feature LBF and cascaded random forest global linear regression. The face detection algorithm and the key point detection algorithm may also be replaced by other algorithms (faster or more accurate algorithms) according to actual needs. The face detection algorithm and the key point detection algorithm are not limited in the present disclosure.

Since there may be significant differences in coordinates of three-dimensional facial key points of different human individuals (such as race, age, gender, etc.) and the face is a typical non-rigid object, the three-dimensional coordinates of facial key points in the target coordinate system may change at any time. After obtaining the 68 two-dimensional target key points, the CPU may perform an iterative optimization on the initial three-dimensional face template to obtain an optimal target three-dimensional face template. The target three-dimensional face template has a best matching effect with the current facial feature of the user.

The CPU may perform a face pose estimation on the user according to the target three-dimensional face template and the PNP pose estimation algorithm so as to obtain a three-dimensional face pose of the face image in the camera coordinate system, and calculate the coordinates of left and right pupils of the user according to the pose in the camera coordinate system. For example, the three-dimensional face pose may be described by 68 three-dimensional key points corresponding to the 68 two-dimensional target key points.

For example, as shown in FIG. 2C, the 68 facial key points do not contain positions of pupil centers. The CPU may calculate a centroid (mean) of the 3D coordinates of six key points (key points 36~41) around the left eye of the face to determine the 3D coordinate Pₗ of the left eye pupil of the user in the camera coordinate system, calculate a centroid of the 3D coordinates of six key points (key points 42~47) around the right eye of the face to determine the coordinates Pᵣ of the right eye pupil of the user in the camera coordinate system, and calculate a grating opening and closing sequence that may present the optimal glasses-free 3D effect for the user according to the pupil coordinates Pₗ and Pᵣ and a grating layout on the screen. The grating opening and closing sequence may include a sequence composed of 0 and 1, where 0 represents the corresponding grating is closed and 1 represents the corresponding grating is open. The CPU transmits the grating opening and closing sequence to an overall driver of the mainboard, and the overall driver controls an output interface of the mainboard to output corresponding high and low levels, so as to control the grating opening and closing on the screen. For example, the output interface may be a General-purpose input/output (GPIO) interface.

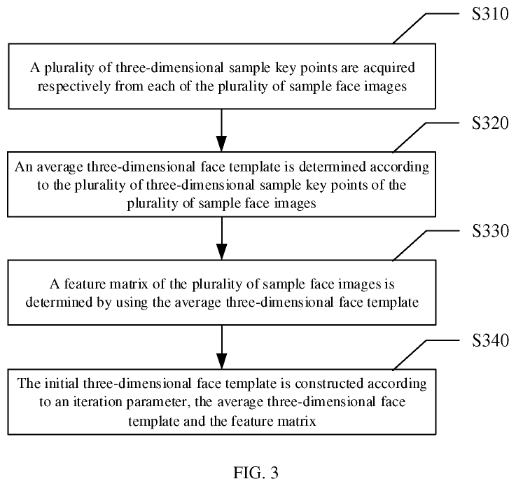

FIG. 3 shows a flowchart of constructing an initial three-dimensional face template according to the embodiments of the present disclosure.

As shown in FIG. 3, step S110 of constructing the initial three-dimensional face template by using the plurality of sample face images may include step S310 to step S340 as follows.

In step S310, a plurality of three-dimensional sample key points are acquired respectively from each of the plurality of sample face images.

In step S320, an average three-dimensional face template is determined according to the plurality of three-dimensional sample key points of the plurality of sample face images.

In step S330, a feature matrix of the plurality of sample face images is determined by using the average three-dimensional face template.

In step S340, the initial three-dimensional face template is constructed according to an iteration parameter, the average three-dimensional face template and the feature matrix.

In the embodiments of the present disclosure, LS3D-W dataset may be used as a data source of the average face template to acquire a plurality of sample face images. 68 three-dimensional sample key points are acquired from each sample face image. It should be noted that the 68 three-dimensional sample key points from each sample face image are distributed in the same way. For example, the 68 three-dimensional sample key points from each sample face image include six key points (key points 36~41) around the left eye of the face and six key points (key points 42~47) around the right eye of the face.

Each key point includes three coordinate values (X, Y and Z) of the key point in the target coordinate system. An average value of all key points at a same potion of the face images may be calculated to determine an average three-dimensional face template mean_shape. The average three-dimensional face template mean_shape includes three coordinate values of 68 average key points, and a unit of the coordinate value may be mm.

The three-dimensional face template mean_shape may be a column vector [X₀, X₁, . . . , X₆₇, Y₀, Y₁, . . . , Y₆₇, Z₀, Z₁, . . . , Z₆₇] T with a dimension of 204*1, where X₀, Y₀ and Z₀ respectively represent the coordinate values of a first average key point.

In the embodiments of the present disclosure, determining the feature matrix of the plurality of sample face images by using the average three-dimensional face template may include: performing a decentralization on the plurality of three-dimensional sample key points of the plurality of sample face images by using the average three-dimensional face template, so as to obtain a covariance matrix; calculating a plurality of feature values of the covariance matrix and a plurality of feature vectors corresponding to the plurality of feature values; determining a plurality of valid feature vectors from the plurality of feature vectors according to contribution values of the plurality of feature values to a linear projection in the covariance matrix, where a sum of the contribution values of the plurality of feature values corresponding to the plurality of valid feature vectors is greater than a predetermined contribution value; and constructing the feature matrix according to the plurality of valid feature vectors.

For example, the facial key point data in the LS3D-W dataset may be analyzed using a principal component analysis algorithm (PCA) to reduce a linear dimension of the key point data. For example, high-dimensional data may be mapped to a low-dimensional space through a linear projection, so that more original data point characteristics may be retained using fewer data dimensions.

For example, a difference calculation may be performed on the 68 key points of each sample face image and the 68 average key points of the average three-dimensional face template mean_shape to achieve decentralization (mean removal). A covariance matrix is constructed from the decentralized 68 key points of each sample face image. A plurality of feature values of the covariance matrix and a plurality of feature vectors corresponding to the feature values may be solved.

Each feature value of the covariance matrix represents the contribution value to the linear projection. The valid feature values are selected from the plurality of feature values. For example, according to an order of numeric values of the feature values, a sum of top N feature values may be calculated. When it is determined that a proportion of the sum of the top N feature values to a sum of all feature values is greater than or equal to 99%, the N feature values are selected as valid feature values. The predetermined contribution value may be 99%. Those skilled in the art may also set other contribution values according to actual needs, which is not limited in the present disclosure. In this case, N=num, and the top num feature values are selected as valid feature values, where N is a positive integer. num represents a minimum feature dimension of the 204-dimensional features of the three-dimensional face image. The feature vectors corresponding to the top num feature values are valid feature vectors. The num valid feature vectors form a feature matrix pv, and the dimension of the feature matrix is 204*num.

In the embodiments of the present disclosure, the initial three-dimensional face template current_shape_3D may be expressed by Equation (2).

current_shape_3D=mean_shape+pv·params (2)

params is the iteration parameter. A changing feature of the face image at different times may be represented by the iteration parameter params.

The dimension of the initial three-dimensional face template current_shape_3D is 204*1, and the dimension of the iteration parameter params is num*1.

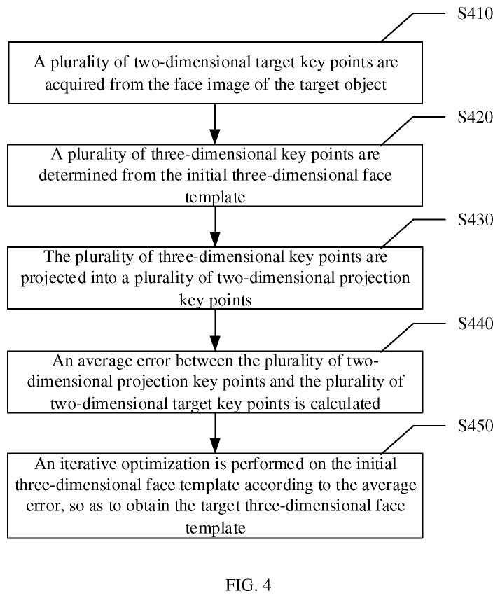

FIG. 4 shows a flowchart of iterating the initial three-dimensional face template according to the embodiments of the present disclosure.

As shown in FIG. 4, step S120 of performing an iterative optimization on the initial three-dimensional face template by using the face image of the target object so as to obtain the target three-dimensional face template may include step S410 to step S440 as follows.

In step S410, a plurality of two-dimensional target key points are acquired from the face image of the target object.

In step S420, a plurality of three-dimensional key points are determined from the initial three-dimensional face template.

In step S430, the plurality of three-dimensional key points are projected into a plurality of two-dimensional projection key points.

In step S440, an average error between the plurality of two-dimensional projection key points and the plurality of two-dimensional target key points is calculated.

In step S450, an iterative optimization is performed on the initial three-dimensional face template according to the average error, so as to obtain the target three-dimensional face template.

In the embodiments of the present disclosure, the two-dimensional target key points may be obtained from the distortion-corrected face image. For example, 68 two-dimensional target key points may be acquired from the distortion-corrected face image. The plurality of three-dimensional key points determined from the initial three-dimensional face template may be unknown key points. For example, the coordinate values of the three-dimensional key points may be a function (X, Y, Z) of the iteration parameter params.

For example, the plurality of three-dimensional key points from the initial three-dimensional face template may be expressed by Equation (3).

current_shape_3D=[X₀X1 . . . X67Y0Y1 . . . Y67Z0Z1 . . . Z67] (3)

By changing Equation (3), a matrix with a dimension of 3*68 may be obtained, which is expressed by Equation (4).

$$current\_shape \_ 3 D = [ \begin{matrix}X 0 & X 1 & … & X 67 \\ Y 0 & Y 1 & … & Y 67 \\ Z 0 & Z 1 & … & Z 67\end{matrix} ] \qquad ( 4 )$$

In the embodiments of the present disclosure, projecting the plurality of three-dimensional key points into a plurality of two-dimensional projection key points may include: constructing a weak perspective projection model params global according to the coordinate values of the three-dimensional key points, a scaling ratio, a coordinate system rotation matrix, and a center point offset vector of the pixel coordinate system; and projecting the plurality of three-dimensional key points into a plurality of two-dimensional projection key points by using the weak perspective projection model.

For example, the weak perspective projection model may be expressed by Equation (5).

params_global=[scale RₓR_{y}R_{z}tₓt_{y}] (5)
where scale represents the scaling ratio, Rₓ represents a rotation amount of the x-axis of the target coordinate system with respect to the x-axis of the camera coordinate system, R_{y} represents a rotation amount of the y-axis of the target coordinate system with respect to the y-axis of the camera coordinate system, R_{z} represents a rotation amount of the z-axis of the target coordinate system with respect to the z-axis of the camera coordinate system, and tₓ and t_{y} respectively represent the offset vectors of the origin of the pixel coordinate system with respect to the origin of the camera coordinate system on the x-axis and y-axis.

For example, the origin of the pixel coordinate system may be located at an upper left corner of the two-dimensional face image, and the origin of the camera coordinate system may be located at a center of an optical axis of the camera. Accordingly, a coordinate point on the optical axis of the camera, such as coordinate point (0,0), may have pixel coordinates (tₓ, t_{y}) in the pixel coordinate system.

In the embodiments of the present disclosure, projecting the plurality of three-dimensional key points from the initial three-dimensional face template into a plurality of two-dimensional projection key points may be expressed by Equation (6).

$$[ \begin{matrix}x \\ y\end{matrix} ] = scale \cdot [ \begin{matrix}{R}_{00} & {R}_{01} & {R}_{02} \\ {R}_{10} & {R}_{11} & {R}_{21}\end{matrix} ] \cdot [ \begin{matrix}X \\ Y \\ Z\end{matrix} ] + [ \begin{matrix}{t}_{x} \\ {t}_{y}\end{matrix} ] \qquad ( 6 )$$

For example, x and y respectively represent the coordinate values of the two-dimensional projection key points on the x-axis and y-axis of the pixel coordinate system, and X, Y and Z respectively represent the coordinate values of the three-dimensional key points on the x-axis, y-axis and z-axis of the target coordinate system. For example, X, Y and Z may represent the coordinate values of the 68 average key points of the initial three-dimensional face template.

$$[ \begin{matrix}{R}_{00} & {R}_{01} & {R}_{02} \\ {R}_{10} & {R}_{11} & {R}_{21}\end{matrix} ]$$

represents a rotation matrix of the target coordinate system with respect to the camera coordinate system.

Equation (4) may be substituted into Equation (6) to obtain Equation (7).

$$current\_shape \_ 2 D = scale \cdot [ \begin{matrix}{R}_{00} & {R}_{01} & {R}_{02} \\ {R}_{10} & {R}_{11} & {R}_{21}\end{matrix} ] \cdot current\_shape \_ 3 D + [ \begin{matrix}{t}_{x} \\ {t}_{y}\end{matrix} ] \qquad ( 7 )$$

Equation (7) shows projecting the three-dimensional key points from the initial three-dimensional face template current_shape_3D onto a plane of the pixel coordinate system to obtain a two-dimensional projection key point matrix current_shape_2D with a dimension of 2*68. Since the three-dimensional key point from the initial three-dimensional face template current_shape_3D is a function (X, Y, Z) of the iteration parameter params, the two-dimensional projection key point in the two-dimensional projection key point matrix current_shape_2D is also a function (x, y) of the iteration parameter params.

For example, the two-dimensional projection key point matrix current_shape 2D may be expressed by Equation (8).

$$current\_shape \_ 2 D = [ \begin{matrix}x 0 & x 1 & … & x 67 \\ y 0 & y 1 & … & y 67\end{matrix} ] \qquad ( 8 )$$

For example, the two-dimensional target key point matrix landmarks_2D formed by the 68 two-dimensional target key points acquired from the distortion-corrected face image may be expressed by Equation (9).

$$landmarks\_ 2 D = [ \begin{matrix}x {0}^{′} & x {1}^{′} & … & x {67}^{′} \\ y {0}^{′} & y {1}^{′} & … & y {67}^{′}\end{matrix} ] \qquad ( 9 )$$

In the embodiments of the present disclosure, calculating the average error between the plurality of two-dimensional projection key points and the plurality of two-dimensional target key points includes: calculating a re-projection error according to the plurality of two-dimensional projection key points and the plurality of two-dimensional target key points; and calculating the average error according to the re-projection error.

Calculating the re-projection error projₑᵣᵣ between the plurality of two-dimensional projection key points and the plurality of two-dimensional target key points according to the two-dimensional projection key point matrix current_shape_2D and the two-dimensional target key point matrix landmarks_2D may be expressed by Equation (10).

$$( 10 )$$

$${proj}_{err} = landmarks\_ 2 D - current\_shape \_ 2 D = [ \begin{matrix}{Error\_X}_{0} & {Error\_X}_{1} & … & {Error\_X}_{67} \\ {Error\_Y}_{0} & {Error\_Y}_{1} & … & {Error\_Y}_{67}\end{matrix} ]$$

Calculating the average error error according to the re-projection error projₑᵣᵣ may be expressed by Equation (11).

$$error = \frac{1}{68} {\sum }_{i = 0}^{67} {‖ {proj}_{err} ‖}^{2} \qquad ( 11 )$$

The re-projection error is expressed as

$${proj}_{err} = landmarks\_ 2 {D}_{l} - current\_shape \_ 2 {D}_{i} = [ \begin{matrix}{Error\_X}_{i} \\ {Error\_Y}_{i}\end{matrix} ] ,$$

where Error_Xᵢ represents a re-projection error between a coordinate value of an i^{th} two-dimensional projection key point and a coordinate value of an i^{th} two-dimensional target key point on the x-axis, and Error_Yᵢ represents a re-projection error between a coordinate value of the i^{th} two-dimensional projection key point and a coordinate value of the i^{th} two-dimensional target key point on the y-axis. In this case, the average error error is a function of the iteration parameter params.

In the embodiments of the present disclosure, the accuracy of the target three-dimensional face template may be measured by the re-projection error, and the re-projection error is related to the iteration parameter params and the parameter of the weak perspective projection model params global. When error reaches a convergence condition through continuous iterative optimization, the iteration parameter params is the optimal iteration parameter, and at this time, the target three-dimensional face template current_shape_3D is the optimal target three-dimensional face template.

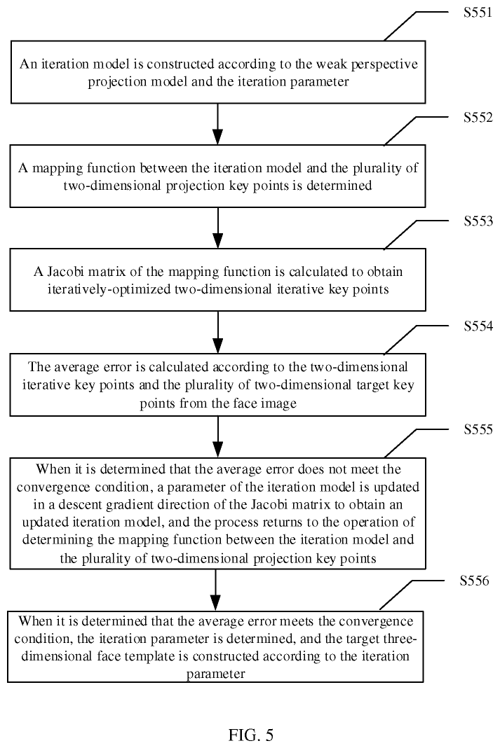

FIG. 5 shows a flowchart of iterating the initial three-dimensional face template according to other embodiments of the present disclosure.

As shown in FIG. 5, step S450 of performing an iterative optimization on the initial three-dimensional face template according to the average error so as to obtain the target three-dimensional face template may include step S551 to step S556 as follows.

In step S551, an iteration model is constructed according to the weak perspective projection model and the iteration parameter.

In step S552, a mapping function between the iteration model and the plurality of two-dimensional projection key points is determined.

In step S553, a Jacobi matrix of the mapping function is calculated to obtain iteratively-optimized two-dimensional iterative key points.

In step S554, the average error is calculated according to the two-dimensional iterative key points and the plurality of two-dimensional target key points from the face image.

In step S555, when it is determined that the average error does not meet the convergence condition, a parameter of the iteration model is updated in a descent gradient direction of the Jacobi matrix to obtain an updated iteration model, and the process returns to the operation in step S552.

In step S556, when it is determined that the average error meets the convergence condition, the iteration parameter is determined, and the target three-dimensional face template is constructed according to the iteration parameter.

In the embodiments of the present disclosure, the mapping function may be expressed by Equation (12).

$$F ( [ \begin{matrix}scale \\ {R}_{x} \\ {R}_{y} \\ {R}_{z} \\ {t}_{x} \\ {t}_{y} \\ params\end{matrix} ] ) = [ \begin{matrix}current\_shape \_ 2 D\_x \\ current\_shape \_ 2 D\_y\end{matrix} ] \qquad ( 12 )$$

$$F ( [ \begin{matrix}scale \\ {R}_{x} \\ {R}_{y} \\ {R}_{z} \\ {t}_{x} \\ {t}_{y} \\ params\end{matrix} ] )$$

is an iteration model for the weak perspective projection model and the iteration parameter.

$$[ \begin{matrix}current\_shape \_ 2 D\_x \\ current\_shape \_ 2 D\_y\end{matrix} ]$$

is a coordinate value matrix of the two-dimensional projection key points, where current_shape_2D_x is an x-axis coordinate value matrix of the 68 two-dimensional projection key points, and current_shape_2D_y is the y-axis coordinate value matrix of the 68 two-dimensional projection key points.

For example:

$$[ \begin{matrix}current\_shape \_ 2 D\_x \\ current\_shape \_ 2 D\_y\end{matrix} ] = current\_shape \_ 2 D = [ \begin{matrix}x 0 & x 1 & … & x 67 \\ y 0 & y 1 & … & y 67\end{matrix} ] .$$

For example, the iteration model may be iteratively optimized using the Jacobi matrix J, and the iteratively optimized two-dimensional iterative key points may be determined in the optimized iteration model.

For example, the Jacobi matrix J of the iteration model may have a dimension of 136*(num+6). The Jacobi matrix J may be obtained by taking partial derivatives of the weak perspective projection model parameters scale, Rₓ, R_{y}, R_{z}, tₓ and t_{y} on the right side of Equation (7) and taking partial derivatives of the weak perspective projection model parameter params on the right side of Equation (12).

The Jacobi matrix J may be expressed by Equation (13) to Equation (20).

$$\frac{\partial ( current\_shape \_ 2 D\_x )}{\partial scale} = current\_shape \_ 3 D \cdot {[ \begin{matrix}{R}_{00} & {R}_{01} & {R}_{02}\end{matrix} ]}^{T} \qquad ( 13 )$$

$$\frac{\partial ( current\_shape \_ 2 D\_y )}{\partial scale} = current\_shape \_ 3 D \cdot {[ \begin{matrix}{R}_{10} & {R}_{11} & {R}_{12}\end{matrix} ]}^{T} \qquad ( 14 )$$

$$[ \begin{matrix}\frac{\partial ( current\_shape \_ 2 D\_x )}{\partial {R}_{x}} \\ \frac{\partial ( current\_shape \_ 2 D\_x )}{\partial {R}_{y}} \\ \frac{\partial ( current\_shape \_ 2 D\_x )}{\partial {R}_{y}}\end{matrix} ] = scale \cdot {( [ \begin{matrix}0 & {R}_{13} & - {R}_{12} \\ - {R}_{13} & 0 & {R}_{11} \\ {R}_{12} & - {R}_{11} & 0\end{matrix} ] \cdot current\_shape \_ 3 {D}^{T} )}^{T} \qquad ( 15 )$$

$$[ \begin{matrix}\frac{\partial ( current\_shape \_ 2 D\_y )}{\partial {R}_{x}} \\ \frac{\partial ( current\_shape \_ 2 D\_y )}{\partial {R}_{y}} \\ \frac{\partial ( current\_shape \_ 2 D\_y )}{\partial {R}_{y}}\end{matrix} ] = scale \cdot {( [ \begin{matrix}0 & {R}_{23} & - {R}_{22} \\ - {R}_{23} & 0 & {R}_{21} \\ {R}_{22} & - {R}_{21} & 0\end{matrix} ] \cdot current\_shape \_ 3 {D}^{T} )}^{T} \qquad ( 16 )$$

$$[ \begin{matrix}\frac{\partial ( current\_shape \_ 2 D\_x )}{\partial {t}_{x}} \\ \frac{\partial ( current\_shape \_ 2 D\_x )}{\partial {t}_{y}}\end{matrix} ] = [ \begin{matrix}1 \\ ⋮ \\ 1 \\ 0 \\ ⋮ \\ 0\end{matrix} ] \qquad ( 17 )$$

$$[ \begin{matrix}\frac{\partial ( current\_shape \_ 2 D\_y )}{\partial {t}_{x}} \\ \frac{\partial ( current\_shape \_ 2 D\_y )}{\partial {t}_{y}}\end{matrix} ] = [ \begin{matrix}0 \\ ⋮ \\ 0 \\ 1 \\ ⋮ \\ 1\end{matrix} ] \qquad ( 18 )$$

$$[ \frac{\partial ( current\_shape \_ 2 D\_x )}{\partial params} ] = scale ( {R}_{00} \cdot pv\_X + {R}_{01} \cdot pv\_Y + {R}_{02} \cdot pv\_Z ) \qquad ( 19 )$$

$$[ \frac{\partial ( current\_shape \_ 2 D\_y )}{\partial params} ] = scale ( {R}_{10} \cdot pv\_X + {R}_{11} \cdot pv\_Y + {R}_{12} \cdot pv\_Z ) \qquad ( 20 )$$

Equation (13) and Equation (14) form a first column of the Jacobi matrix J, Equation (15) and Equation (16) form a second column to a fourth column of the Jacobi matrix J, Equation (17) and Equation (18) form a fifth column and a sixth column of the Jacobi matrix J, and Equation (19) and Equation (20) form a seventh column to a (num+6)^{th} column of the Jacobi matrix J.

In Equation (19) and Equation (20), pv_X represents a first row to a 68th row of the feature matrix pv, pv_Y represents a 69th row to a 138th row of the feature matrix pv, and pv_Z represents a 139^{th} row to a 204^{th} row of the feature matrix pv. pv_X, pv_Y and pv_Z have a dimension of 68*num.

For example, during a first iteration of the iteration model, an initial value may be set for the weak perspective projection model parameter. For example, Rₓ=0, R_{y}=0, R_{z}=0. scale represents a ratio of a size of the average three-dimensional face template to a facial region detected in the face detection algorithm module. tₓ and t_{y} are determined by the center coordinates of the facial region on the plane of the two-dimensional face image, and the initial values of tₓ and t_{y} may both be 0.

The re-projection error projₑᵣᵣ may be calculated after each iteration optimization, and the iteration model may be updated according to the re-projection error projₑᵣᵣ after each iteration optimization. Updating the iteration model includes: calculating a parameter variation of the iteration model according to the descent gradient direction of the Jacobi matrix and the average error; and updating the parameter of the iteration model according to the parameters variation to obtain the updated iteration model.

For example, when the average error does not meet the convergence condition, a movement direction (descent gradient direction) of the Jacobi matrix J may be determined according to a gradient descent principle, and the parameter variation of the iteration model may be calculated. The iteration model may be updated according to the parameter variation, and the mapping function between the iteration model and the two-dimensional projection key points may be re-determined.

For example, calculating the parameter variation delta of the iteration model may be expressed by Equation (21).

delta=0.75·T·projₑᵣᵣ (21)

For example, updating the iteration model may be expressed by Equation (22).

$$[ \begin{matrix}{scale}^{′} \\ {R}_{x}^{′} \\ {R}_{y}^{′} \\ {R}_{z}^{′} \\ {t}_{x}^{′} \\ {t}_{y}^{′} \\ {params}^{′}\end{matrix} ] = [ \begin{matrix}scale \\ {R}_{x} \\ {R}_{y} \\ {R}_{z} \\ {t}_{x} \\ {t}_{y} \\ params\end{matrix} ] - delta \qquad ( 22 )$$

where

$$[ \begin{matrix}{scale}^{′} \\ {R}_{x}^{′} \\ {R}_{y}^{′} \\ {R}_{z}^{′} \\ {t}_{x}^{′} \\ {t}_{y}^{′} \\ {params}^{′}\end{matrix} ]$$

represents the updated iteration model, and

$$[ \begin{matrix}scale \\ {R}_{x} \\ {R}_{y} \\ {R}_{z} \\ {t}_{x} \\ {t}_{y} \\ params\end{matrix} ]$$

represents the un-updated iteration model.

For example, the re-projection error projₑᵣᵣ may be calculated after each iterative optimization, and the average error error may be calculated according to the re-projection error projₑᵣᵣ. When it is determined that the average error error almost has no change, it is considered that the average error error converges.

For example, it is considered that the average error error converges when an average projection error currentₑᵣᵣₒᵣ obtained after a complete of the iterative optimization and an average projection error lastₑᵣᵣₒᵣ obtained after a complete of a previous iteration optimization meet Equation (23).

current_error>0.999·last_error (23)

When it is determined that the average errors meet the convergence condition, an iteration parameter params' may be determined, and the target three-dimensional face template may be constructed according to the iteration parameter params′. The target three-dimensional face template may be current_shape_3D=mean_shape+pv·params′.

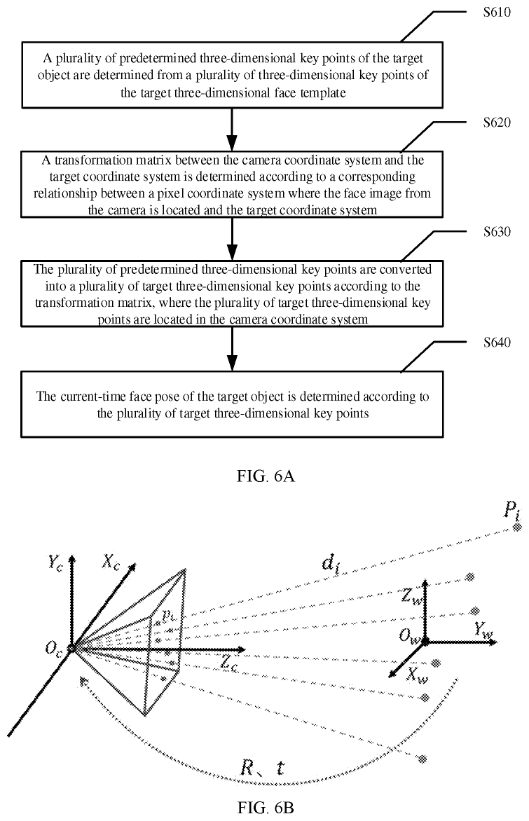

FIG. 6A shows a flowchart of determining a face pose of a target object according to the embodiments of the present disclosure. FIG. 6B shows a schematic diagram of a transformation from a target coordinate system to a camera coordinate system according to the embodiments of the present disclosure.

As shown in FIG. 6A, step S130 of determining the current face pose of the target object according to the corresponding relationship between the current face image of the target object and the target three-dimensional face template may include step S610 to step S640 as follows.

In step S610, a plurality of predetermined three-dimensional key points of the target object are determined from a plurality of three-dimensional key points of the target three-dimensional face template.

In step S620, a transformation matrix between the camera coordinate system and the target coordinate system is determined according to a corresponding relationship between a pixel coordinate system where the face image from the camera is located and the target coordinate system.

In step S630, the plurality of predetermined three-dimensional key points are converted into a plurality of target three-dimensional key points according to the transformation matrix, where the plurality of target three-dimensional key points are located in the camera coordinate system.

In step S640, the current face pose of the target object is determined according to the plurality of target three-dimensional key points.

For example, the plurality of predetermined three-dimensional key points correspond to a plurality of specified two-dimensional key points of the current face image of the target object. The plurality of specified two-dimensional key points of the current face image may be located in a specified facial region that requires a face pose estimation. For example, the plurality of specified two-dimensional key points may be located in a region around the eyes of the user. According to the plurality of specified two-dimensional key points around the eyes, a plurality of predetermined three-dimensional key points around the eyes of the user may be determined in a corresponding region of the target three-dimensional face template. The positions of the pupils of the user may be determined according to the plurality of predetermined key points around the eyes of the user. The plurality of predetermined three-dimensional key points are located in the target coordinate system.

Through the PNP pose estimation algorithm, the two-dimensional coordinates in the pixel coordinate system may correspond to the three-dimensional coordinates in the target coordinate system respectively, thereby solving a transformation matrix

$$[ \begin{matrix}{R}_{t} & t \\ 0 & 1\end{matrix} ]$$

to transform the target coordinate system W to the camera coordinate system C.

As shown in FIG. 6B, a coordinate origin O_{W} of the target coordinate system W is transformed into a coordinate origin O_{C} of the camera coordinate system through the transformation matrix, and a coordinate point Pᵢ of the target coordinate system W is transformed into a coordinate point pᵢ of the camera coordinate system through the transformation matrix.

For example, the transformation matrix between the camera coordinate system and the target coordinate system may be determined by Equation (24).

$$c [ \begin{matrix}x \\ y \\ z\end{matrix} ] = K \cdot [ \begin{matrix}{R}_{t} & t \\ 0 & 1\end{matrix} ] \cdot [ \begin{matrix}X \\ Y \\ Z \\ 1\end{matrix} ] \qquad ( 24 )$$

where c represents a scale of the camera, x and y respectively represent the coordinate values of the two-dimensional projection key points on the x-axis and y-axis of the pixel coordinate system, X, Y and Z respectively represent the coordinate values of the predetermined three-dimensional key points on the x-axis, y-axis and z-axis of the target coordinate system, and K is a camera internal parameter matrix.

According to the characteristics of the transformation matrix, the transformation matrix includes a rotation angle Rₜ of three axes (x-axis, y-axis and z-axis) and a translation amount t in three axis directions. Since the two-dimensional key points include 68 key points, an overdetermined system of equations including 2*68=136 equations may be constructed by the 68 key points. The rotation angle Rₜ of three axes (x-axis, y-axis and z-axis) and the translation amount t in the three axis directions may be solved through the 136 equations.

For example, the overdetermined system of equations including 136 equations may be expressed by:

$$x = {( {A}^{T} \cdot A )}^{- 1} \cdot {A}^{T} \cdot b ,$$

$$where$$

$$x = [ \begin{matrix}{R}_{t} & t \\ 0 & 1\end{matrix} ] ,$$

$$A = K [ \begin{matrix}X \\ Y \\ Z \\ 1\end{matrix} ] ,$$

$$b = c [ \begin{matrix}x \\ y \\ 1\end{matrix} ] .$$

The least squares solution is solved for the overdetermined system of equations to avoid a detection error or excessive error of individual key point that may cause a deviation in a final face position estimation result.

The present disclosure further provides a verification method for verifying the accuracy of the target three-dimensional face template of the present disclosure.

For example, a depth sensor may be fixedly installed on a 3D screen interactive device, and a transformation matrix T between the depth sensor and an ordinary monocular camera of the 3D screen interactive device may be calibrated using tools such as Stereo Camera Calibrator toolbox in matlab or stereoCalibrate function in OpenCV library.

Assuming that at a particular time instant, the 3D coordinates of the user pupil in the camera coordinate system of the 3D screen interactive device are [x, y, z]^{T}, which may be transformed to coordinates [x′, y′, z′]^{T} in the depth sensor coordinate system. The transformation relationship between the two is expressed as follows.

$$[ \begin{matrix}{x}^{′} \\ {y}^{′} \\ {z}^{′} \\ 1\end{matrix} ] = T [ \begin{matrix}x \\ y \\ z \\ 1\end{matrix} ]$$

The 3D coordinates of the pupil acquired by the depth sensor are determined as true values, the 3D coordinates of the pupil obtained by the target three-dimensional face template determined in the embodiments of the present disclosure are converted into 3D coordinates in the depth sensor coordinate system through the matrix T, and the converted 3D coordinates may be compared with the true values to verify the accuracy of the target three-dimensional face template determined in the embodiments of the present disclosure.

A verification result shows that the 3D coordinates of the pupil obtained by the target three-dimensional face template determined in the embodiments of the present disclosure at different viewing distances have small errors in the x-axis, y-axis and z-axis directions, and the errors are stable.

The error may be introduced due to a calibration error in the transformation matrix between the depth sensor and the camera or an error in the facial key point detection. Since the error of the target three-dimensional face template determined in the embodiments of the present disclosure is stable, the error may be compensated by adding a fixed deviation in practical use. The target three-dimensional face template determined in the embodiments of the present disclosure is reliable in terms of accuracy and stability, and has a practical value.

Currently, there are industry-standard definitions for facial key points, such as the 5-point and 68-point standards, as well as custom definitions developed by different companies or research institutions, such as the 106-point standard. These various standards define the anatomical locations of key points on the face in different ways. Taking the left eye as an example, under the 68-point standard, the key points corresponding to the left eye are points numbered 36 to 41 among the 68 key points on the facial template, totaling six key points, as shown in FIG. 2C. Under the 106-point standard, the left eye has 10 key points (including 2 points inside the eye). As shown in FIG. 7, these 10 key points are the left eye top (left_eye_top), the left eye upper right quarter (left_eye_upper_right_quarter), the left eye upper left quarter (left_eye_upper_left_quarter), the left eye left corner (left_eye_left_corner), the left eye pupil (left_eye_pupil), the left eye lower left quarter (left_eye_lower_left_quarter), the left eye right corner (left_eye_right_corner), the left eye bottom (left_eye_bottom), the left eye lower right quarter (left_eye_lower_right_quarter), and the left eye center (left_eye_center).

In practice, the facial key point extraction component of the algorithm (i.e., the deep learning part, which accounts for the majority of computing resource usage and time consumption) may be adjusted as needed, depending on the platform's computing power and the specific requirements for accuracy and time consumption. In such cases, a region-based mapping of key points may be performed, for example, mapping the aforementioned 106 key points to the 68 key points described in the above embodiment. During mapping, the key points may be divided into multiple regions based on facial topology, and region-wise mapping are carried out without retraining the algorithm. The subsequent optimization and iteration of the facial template may be implemented using the method described in the above embodiment.

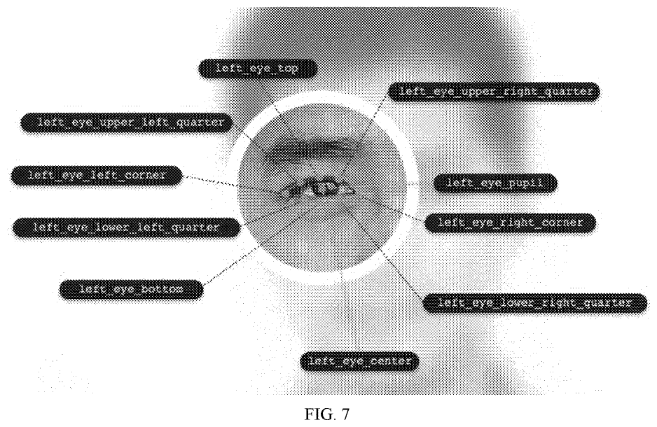

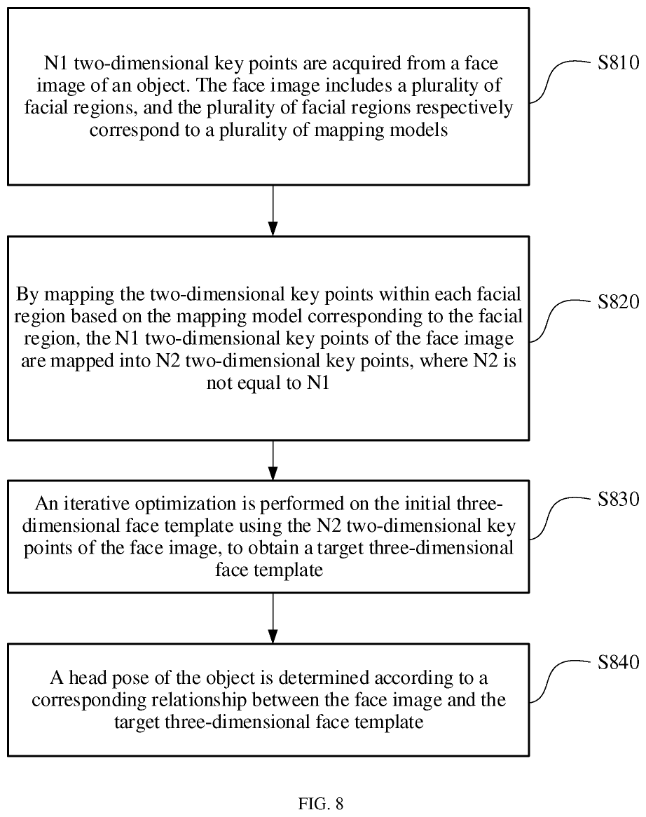

In view of this, embodiments of the present disclosure provide another method of processing an image, in which region-based mapping of key points is performed prior to iterative optimization, so as to uniformly convert different numbers of key points into a number of key points supported by an algorithm. A detailed description will be given below with reference to FIGS. 8 to 12D.

As shown in FIG. 8, the method of processing the image includes operations S810 to S840.

In operation S810, N1 two-dimensional key points are acquired from a face image of an object. The face image includes a plurality of facial regions, and the plurality of facial regions respectively correspond to a plurality of mapping models.

The mapping model may be obtained by fitting existing sample face images. For example, from each of a plurality of sample face images, N1 two-dimensional key points may be acquired as first key points, and N2 two-dimensional key points may be acquired as second key points. Next, a mapping relationship between the first key points and the second key points within each facial region may be fitted to obtain a mapping model for that facial region. The N1 two-dimensional key points and the N2 two-dimensional key points may be defined based on different key point definition standards. For example, the N1 two-dimensional key points may be key points defined based on a first standard, and the N2 two-dimensional key points may be key points defined based on a second standard, for example, N1=106, N2=68.

The fitting process of the mapping model for each facial region may include: generating a first matrix based on positions of the first key points within the facial region; generating a second matrix based on positions of the second key points within the facial region; and calculating a linear mapping matrix from the first matrix to the second matrix as the mapping model for the facial region.

The fitting process of the mapping model corresponding to the left eye region is schematically described below by taking the left eye region as an example.

Assume that the first standard is the above-described standard defining 106 two-dimensional key points, and the second standard is the above-described standard defining 68 two-dimensional key points. Key point detection may be performed on a face dataset of approximately 5 k samples using both the 106-point key point detection algorithm (i.e., detecting key points according to the first standard) and the 68-point facial key point detection algorithm (i.e., detecting key points according to the second standard).

Under the 68-point standard (as shown in FIG. 2C), the left eye has a total of 6 key points. Under the 106-point standard (as shown in FIG. 7), the left eye has a total of 10 key points. It is considered that there is no one-to-one correspondence between the 6 points under the 68-point standard and the 10 points under the 106-point standard, and each mapped point is determined collectively by the entire region to which it belongs before mapping. Assume that the 6 key points of the left eye in the 68-point template are denoted as pᵢ, i=0, . . . , m, m=5, and the 10 key points of the left eye in the 106-point template are denoted as Pᵢⱼ=(Xᵢⱼ, Yᵢⱼ), j=0, . . . , n, n=9.

For the left eye corner point p₀=(x₀, y₀), it is considered that p₀ may be expressed as a linear combination of P₀₀ to P₀₉. Similarly, another key point p₁ of the left eye may be expressed as a linear combination of P₁₀ to P₁₉, and so on, thereby obtaining the following equation (25).

p₀=a₀P₀₀+a₁P₀₁+ . . . aₙP₀ₙ+P_{b}

p₁=a₀P₁₀+a₁P₁₁+ . . . aₙP₁ₙ+P_{b}

pₘ=a₀Pₘ₀+a₁Pₘ₁+ . . . aₙPₘₙ+P_{b} (25)

For this mapping relationship, there are n+1 unknown parameters a₀ to aₙ and an unknown point P_{b}=(X_{b}, Y_{b}), totaling n+3 unknowns (for the case of 10 key points of the left eye, n=9, totaling 12 unknowns). Therefore, at least 12 equations are needed to solve these unknowns. As the coordinates of each point are 2-dimensional, that is, the points on one image may generate 2 equations, expanding equation (25) yields:

$$[ \begin{matrix}{X}_{00} & {X}_{01} & ⋯ & {X}_{0 n} & 1 & 0 \\ {Y}_{00} & {Y}_{01} & ⋯ & {Y}_{0 n} & 0 & 1 \\ ⋮ & ⋮ & & ⋮ & ⋮ & ⋮ \\ {X}_{m 0} & {X}_{m 1} & ⋯ & {X}_{mn} & 1 & 0 \\ {Y}_{m 0} & {Y}_{m 1} & ⋯ & {Y}_{mn} & 0 & 1\end{matrix} ] [ \begin{matrix}{a}_{0} \\ {a}_{1} \\ ⋮ \\ {X}_{b} \\ {Y}_{b}\end{matrix} ] = [ \begin{matrix}{x}_{0} \\ {y}_{0} \\ ⋮ \\ {x}_{m} \\ {Y}_{m}\end{matrix} ] \qquad ( 26 )$$

When calculating the mapping relationship, at least 6 images are randomly selected each time, and a system of equations is established according to equation (26). The above equation (26) may be written as:

A·X=B (27)

$$where A = [ \begin{matrix}{X}_{00} & {X}_{01} & ⋯ & {X}_{0 n} & 1 & 0 \\ {Y}_{00} & {Y}_{01} & ⋯ & {Y}_{0 n} & 0 & 1 \\ ⋮ & ⋮ & & ⋮ & ⋮ & ⋮ \\ {X}_{m 0} & {X}_{m 1} & ⋯ & {X}_{mn} & 1 & 0 \\ {Y}_{m 0} & {Y}_{m 1} & ⋯ & {Y}_{mn} & 0 & 1\end{matrix} ] ,$$

$$A = [ \begin{matrix}{a}_{0} \\ {a}_{1} \\ ⋮ \\ {X}_{b} \\ {Y}_{b}\end{matrix} ] ,$$

$$B = [ \begin{matrix}{x}_{0} \\ {y}_{0} \\ ⋮ \\ {x}_{m} \\ {Y}_{m}\end{matrix} ]$$

A is a matrix formed based on the positions of the n+1 key points of the left eye in each of the m+1 images, also referred to as a first matrix. B is a matrix formed by the positions of the 6 key points mapped from matrix A, also referred to as a second matrix. X is a coefficient matrix, i.e., the mapping model described above. Equation (27) may be solved to obtain matrix X:

X=A⁻¹·B

In the case of m=5, n=9, there are 12 equations and 12 unknowns in the above equation (26), and the matrix X may be solved by the above equation (27). In some embodiments, when the number of equations is greater than the number of unknowns, for example, when the number of images is greater than the number of mapped key points, the least squares solution of X may be obtained by calculating A⁻¹=(A^{T}·A)⁻¹·A^{T}. In some embodiments, random sampling may be performed multiple times, and the obtained matrices X may be averaged to obtain the coefficients of the mapping relationship.

In operation S820, by mapping the two-dimensional key points within each facial region based on the mapping model corresponding to the facial region, the N1 two-dimensional key points of the face image are mapped into N2 two-dimensional key points, where N2 is not equal to N1.

Also taking the left eye region as an example, matrix M′ formed by coordinates of the 10 two-dimensional key points of the left eye region under the 106-point standard is multiplied with the mapping matrix X fitted in operation S810 according to the above equation (26), so as to obtain a matrix B′, where matrix B′ represents coordinates of the 6 two-dimensional key points of the left eye region under the 68-point standard.

In operation S830, an iterative optimization is performed on the initial three-dimensional face template using the N2 two-dimensional key points of the face image, to obtain a target three-dimensional face template.

For the iterative optimization of the initial three-dimensional face template, reference may be made to any of the above embodiments, for example, the iterative optimization methods described above with reference to FIGS. 4 and 5, which will not be repeated here. The N2 two-dimensional key points obtained by mapping in operation S820 correspond one-to-one to a plurality of three-dimensional key points in the initial three-dimensional face template, allowing error calculation between the N2 two-dimensional key points and the plurality of three-dimensional key points and implementing the subsequent iterative operations.

In operation S840, a head pose of the object is determined according to a corresponding relationship between the face image and the target three-dimensional face template.

Operation S840 may be implemented by referring to the methods described above with reference to FIGS. 6A and 6B. For example, a plurality of predetermined three-dimensional key points of the object may be determined from a plurality of three-dimensional key points of the target three-dimensional face template. The plurality of predetermined three-dimensional key points are located in a target coordinate system, and the plurality of predetermined three-dimensional key points correspond to a plurality of specified two-dimensional key points of the face image of the object. Then, a transformation matrix between a camera coordinate system and the target coordinate system may be determined according to a corresponding relationship between a pixel coordinate system where the face image from a camera is located and the target coordinate system. According to the transformation matrix, the plurality of predetermined three-dimensional key points are converted into a plurality of target three-dimensional key points, and the plurality of target three-dimensional key points are located in the camera coordinate system. According to the plurality of target three-dimensional key points, the head pose of the object is determined. For the specific implementation of the above steps, reference may be made to the above description, which will not be repeated here.

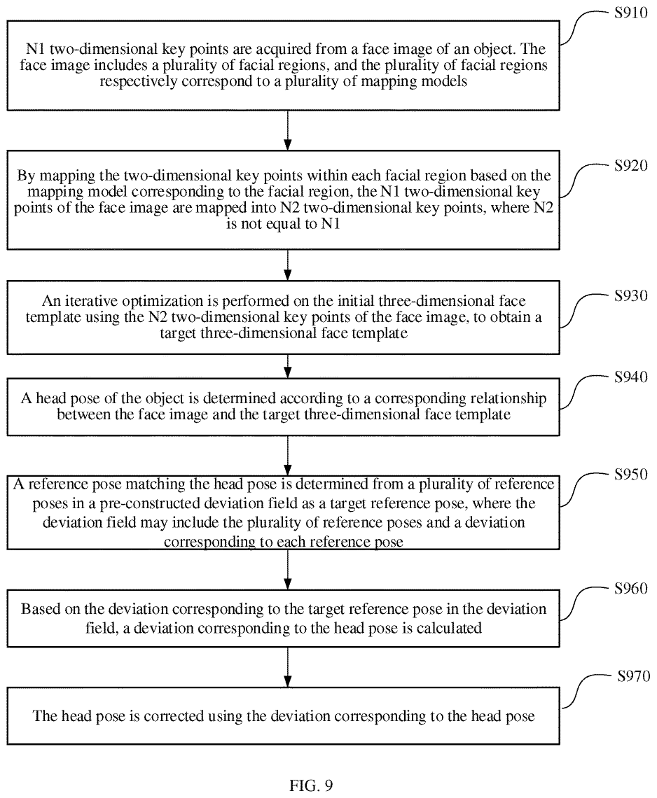

FIG. 9 shows a method of processing an image according to another embodiment of the present disclosure. Compared with the embodiment of FIG. 8, the difference of this method is at least that after determining the head pose of the object, the head pose is corrected based on a pre-constructed deviation field.

As shown in FIG. 9, operations S910 to S940 may be the same as operations S810 to S840 in the above embodiments, which will not be repeated here.

Next, in operations S950 to S970, the head pose of the object determined in operation S940 may be corrected.

In operation S950, a reference pose matching the head pose is determined from a plurality of reference poses in a pre-constructed deviation field as a target reference pose, where the deviation field may include the plurality of reference poses and a deviation corresponding to each reference pose.

For example, based on the plurality of reference poses, a position interval in which the head pose is located may be determined, the position interval being defined by reference poses that are adjacent in position. Next, the reference poses defining the position interval are used as the target reference poses.

In operation S960, based on the deviations corresponding to the target reference poses in the deviation field, a deviation corresponding to the head pose is calculated. For example, according to the position of the head pose within the position interval, interpolation calculation may be performed on a deviation interval defined by the deviations corresponding to the target reference poses to obtain the deviation corresponding to the head pose.

In operation S970, the head pose is corrected using the deviation corresponding to the head pose.

In some embodiments, the method of processing the image may further include constructing a deviation field. The construction of the deviation field may be performed at any suitable stage. Taking the embodiment of FIG. 9 as an example, the deviation field may be constructed before operation S910, that is, before starting head pose detection. The deviation field may also be constructed before operation S940, that is, at any stage before completing the head pose detection. The embodiments of the present disclosure are not limited to this, and the construction of the deviation field may also be performed after operation S940 and before operation S950, that is, detecting the head pose, then constructing the deviation field, and then correcting the head pose based on the deviation field. In practical applications, the timing of constructing the deviation field may be selected as needed.

The construction process of the deviation field will be described in detail below with reference to FIG. 10.

In operation S1010, a virtual calibration target having a pose is presented.

The virtual calibration target may be a sphere, and the sphere includes a first portion having a first color and a second portion having a second color.

In operation S1020, in response to detecting that a line of sight of the object is aligned with the virtual calibration target, a face image of the object is captured as a reference image, and the above described operations of acquiring N1 two-dimensional key points, mapping, iterative optimization, and determining the head pose of the object are performed on the reference image to obtain a reference pose of the object.

Various methods may be used to determine whether the line of sight of the object is aligned with the virtual calibration target. For example, the alignment between the line of sight of the object and the virtual calibration target may be determined according to a confirmation signal provided by the object. In other examples, the alignment between the line of sight of the object and the virtual calibration target may be determined by detecting the line of sight of the object. Whenever alignment of the line of sight is detected, a face image of the object may be captured as a reference image, and the reference pose of the object may be obtained by performing, for example, the above operations S810 to S840 or the above operations S910 to S940, on the reference image.

In operation S1030, a deviation between the reference pose and the pose of the virtual calibration target is calculated.

For example, based on the pose of the virtual calibration target and calibration information on the virtual calibration target, a pupil position of the object when the line of sight of the object is aligned with the virtual calibration target may be calculated as a theoretical position. The pupil position of the object is obtained from the reference pose of the object as a detected position. Next, a deviation between the theoretical position and the detected position is calculated as the deviation between the reference pose and the pose of the virtual calibration target.

In operation S1040, the pose of the virtual calibration target is changed, and the process returns to operation S1010, so as to obtain a plurality of reference poses of the object and a deviation between each reference pose and a corresponding pose of the virtual calibration target.

Changing the pose of the virtual calibration target includes at least one of: translating the virtual calibration target along a first direction, or rotating the virtual calibration target along a second direction. The first direction is a depth direction in a screen coordinate system where the virtual calibration target is presented, and the second direction is a horizontal direction in a screen coordinate system. The theoretical position and the detected position each include at least one of a coordinate in the depth direction and a coordinate in the horizontal direction.

In operation S1050, a deviation field is constructed based on the plurality of reference poses and the deviation between each reference pose and the corresponding pose of the virtual calibration target.

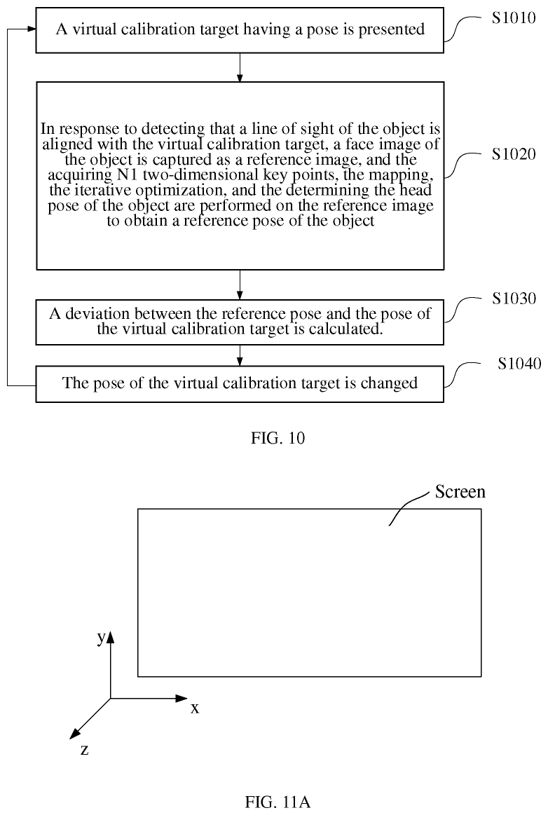

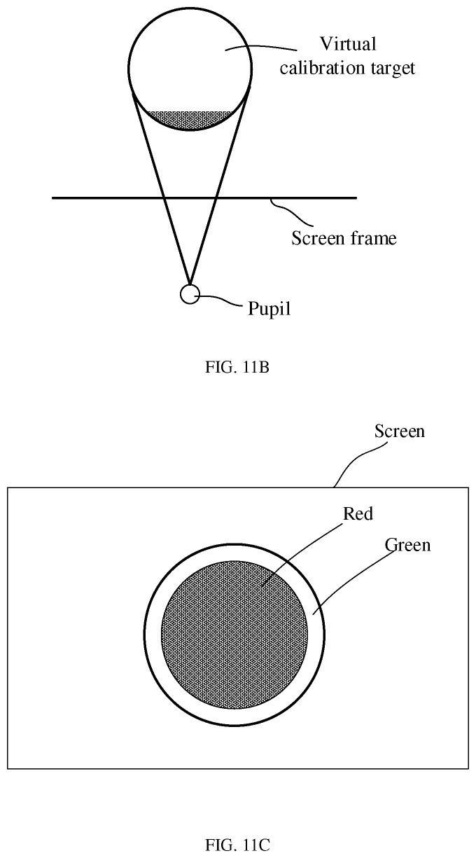

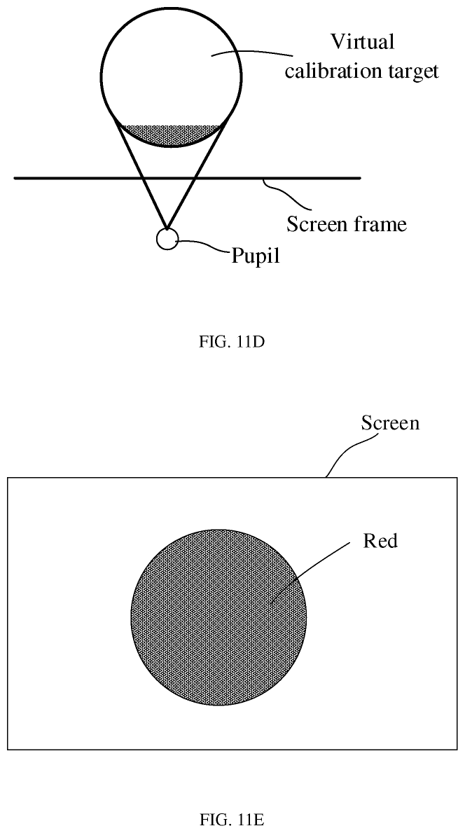

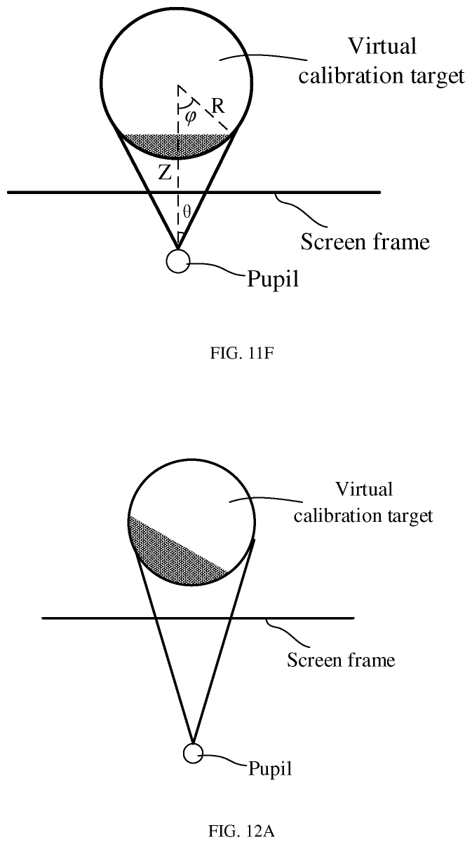

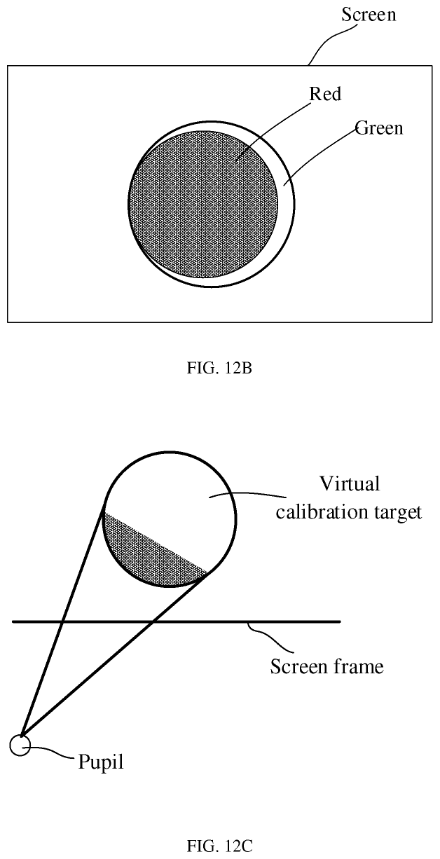

Examples of constructing the deviation field and correcting the head pose based on the deviation field are described below with reference to FIGS. 11A to 12D.

The hardware environment for constructing the deviation field may be the same as that for the above method of processing the image, i.e., including a camera, a screen, and a processor. In an application scenario, the camera and the screen may be fixedly installed. The screen coordinate system is shown in FIG. 11A, with the center as the coordinate origin, the x-axis representing the horizontal rightward direction (with the person facing the screen), the y-axis representing the vertical upward direction, and the z-axis representing the direction from the screen pointing to the viewer, also referred to as the depth direction.

The distance (stereoscopic perception) at which the eye of the user sees an object is determined by the horizontal disparity of the same point in the left and right eyes. Therefore, for a 3D display screen, its displayed content is usually related to the horizontal position of the eye relative to the screen and the distance/direction of the eye relative to the screen. Thus, in the following examples, we focus on the x-coordinate and z-coordinate of the eye in the screen coordinate system for deviation calibration. However, those skilled in the art should understand that the embodiments of the present disclosure are not limited thereto. A pose may include a position and an orientation. The position may include the x-coordinate, y-coordinate, and z-coordinate as described above, and the orientation may include a pitch angle, a yaw angle, and a roll angle. In some embodiments, any one or more of the 6-dimensional parameters of the pose may be selected as calibration parameters as needed. For example, position coordinates in the x, y, z directions may be selected as calibration parameters, or the x-coordinate, y-coordinate, and rotation angle may be selected as calibration parameters.

After PNP pose estimation, the three-dimensional coordinates (in camera coordinate system) of the 68 facial key points in the camera (integrated at the edge of the screen) may be obtained. The transformation relationship between the camera coordinate system and the screen coordinate system may be calibrated in advance, for example, by capturing a checkerboard displayed on the screen by the camera and obtaining the transformation relationship between the camera and the screen based on specular reflection or other methods. Accordingly, the three-dimensional coordinates of the 6 eye key points in the screen coordinate system shown in FIG. 11A are obtained. Usually, the average of the coordinates of the 6 eye key points is calculated as the three-dimensional coordinates of the pupil. However, due to calibration and algorithm errors, there is a difference between the three-dimensional coordinates and the true values. Therefore, the following method is designed to calibrate this error value and reduce the final error.

For example, the display module may be removed from the display, leaving the frame of the display and the fixed part of the camera, while a spherical calibration jig as shown in the FIGS. 11B to 11F is made, with part of the spherical calibration jig painted red and part green. The jig is placed behind the frame to simulate a user viewing virtual 3D content displayed on the screen. At this point, the camera feeds back the current x and z coordinates of the left eye of the user in real time. In some embodiments, the calibration target may be in a virtual form. For example, a virtual calibration target may be displayed on the screen. The positional relationship between the eye(s) and the virtual calibration target may be determined based on the transformations among the coordinate system of the virtual scene in which the virtual calibration target resides, the screen coordinate system, and the real-world coordinate system.

The construction and use of the deviation field in the z-axis direction are described below with reference to FIGS. 11B to 11F.

As shown in FIG. 11B, the virtual calibration target may be a sphere. The sphere includes a first portion having a first color and a second portion having a second color. For example, the unfilled portion represents the green portion, and the patterned portion represents the red portion. The sphere is arranged on the center line of the screen, symmetrical left and right, and the position of the sphere in the screen coordinate system is predetermined.

The user looks straight ahead at the sphere, and moves left or right to change his/her viewing position until the red portion is at the center of the green portion. The picture seen at this time is shown in FIG. 11C.

Next, the user moves forward until the red sphere is critically visible, as shown in FIGS. 11D and 11E.

By changing the placement position of the sphere, the transformation relationship between the pupil coordinates computed by the algorithm (mainly focusing on x and z coordinates) and the placement position of the sphere may be collected multiple times.

The theoretical pupil position may be calculated from the intersection of tangent lines at the edge of the red area, as shown in FIG. 11F. Assume the sphere radius is R, the red area is a spherical cap (e.g., rotationally symmetric about the horizontal axis, with red corresponding to a certain viewing angle range). When the user “just sees red”, his/her line of sight is tangent to the sphere at the boundary of the red area. If the half-apex angle corresponding to the boundary of the red area is 0 (the angle between the line from the pupil to the boundary point and the line from the sphere center to the pupil), then the distance from the pupil to the sphere center is: Z=R/sin θ. θ may be determined by the spherical angle occupied by the red area in the jig design (e.g., if red is painted to a latitude φ, then θ=90°−φ). In some embodiments, a detection instrument (e.g., a laser tracker) may also be used in advance to measure the true Z corresponding to the critical state at several known pupil positions, and an empirical value of θ may be fitted.

From this, the theoretical distance Z from the user's pupil to the sphere center may be obtained. By comparing the theoretical distance Z with the z value in the head pose obtained by the pose detection algorithm (for example, by performing the above operations S810 to S840, or by performing operations S910 to S940), the deviation value Δz may be obtained. Multiple measurements may be performed to obtain the mean of multiple values of Δz. However, it is possible that the deviation value is not fixed. A correspondence between z and Z may be established and the data may be arranged in ascending order of z.

For example, the spherical jig may be moved to M different depth positions (behind the screen). At each position, the user adjusts to the critical state (just seeing red), and the pupil coordinate z (screen coordinate system, positive in the user direction) in the head pose computed by the pose detection algorithm is recorded, and the true distance Zₜᵣᵤₑ from the pupil to the screen plane calculated by the geometric relationship is recorded. Then, the deviation at each calibration point is calculated by:

Δz=Zₜᵣᵤₑ−z (28)

For the M different depth positions, M vales of z and corresponding deviations Δz are obtained. For example, the data pairs may be arranged in ascending order of z value to obtain ordered data pairs: (z₁, Δz₁), (z₂, Δz₂), . . . , (z_{M}, Δz_{M}). Thus, the construction of the z-axis coordinates and corresponding deviations in the deviation field is completed, i.e., the z-axis calibration is completed.

Next, how to use the z-axis calibration information in the above deviation field to correct the head pose after detecting the head pose is described.

For example, after obtaining the head pose in operation S940 described above, a new pupil z-axis coordinate z_{*} is obtained. The z-axis coordinate interval to which the new pupil z-axis coordinate z_{*} belongs may be determined, and the true deviation Δz_{*} corresponding to z_{*} is obtained by linear interpolation, and then the corrected true coordinate Ztrue is obtained.

First, coordinates zᵢ and zᵢ₊₁ are determined in the deviation field such that: zᵢ≤z_{*}≤zᵢ₊₁ In the interval [zᵢ, zᵢ₊₁], assuming that the deviation varies linearly with the z-coordinate obtained from the algorithm, the following equation (29) is obtained:

$$Δ {z}_{*} = Δ {z}_{i} + \frac{Δ {z}_{i + 1} - Δ {z}_{i}}{{z}_{i + 1} - {z}_{i}} ( {z}_{*} - {z}_{i} ) \qquad ( 29 )$$

where

$$\frac{Δ {z}_{i + 1} - Δ {z}_{i}}{{z}_{i + 1} - {z}_{i}}$$

is the slope of the interval, and (z_{*}−zᵢ) is the distance of the current coordinate value from the left endpoint of the interval.

Next, the corrected true coordinate is calculated according to equation (30):

Zₜᵣᵤₑ=Z_{*}+Δz_{*} (30)

Assume that the deviation field data shown in Table 1 below (unit: mm) is obtained by calibration.

TABLE 1

| zᵢ | Z_{true, i} | Δzᵢ = Z_{true, i} − zᵢ |
|---|---|---|
| 400 | 405 | +5 |
| 500 | 508 | +8 |
| 600 | 615 | +15 |

When using the deviation field for pose correction, the pose detection algorithm outputs z_{*}=550, which falls in the interval [500, 600]. According to the above equation (29), the slope k=(15−8)/(600−500)=0.07 may be calculated, and then the deviation corresponding to z_{*} is calculated as Δz_{*}=8+0.07×(550−500)=11.5. According to the above equation (30), the true coordinate corresponding to z_{*} may be calculated as Zₜᵣᵤₑ=550+11.5=561.5 mm. Thus, the correction of the head pose in the z-axis direction is completed.

The construction and use of the deviation field in the x-axis direction are described below with reference to FIGS. 12A to 12D.

As shown in FIG. 12A, the sphere is rotated by a certain angle, for example, rotated 30 degrees to the left. It may be foreseen that the user sees the sphere as shown in FIG. 12B. If the left eye moves to the left at this time, a critical state in which the user see only the red part of the sphere would be reached, i.e., the user's line of sight is aligned with the calibration target, as shown in FIGS. 12C and 12D.

When the user's line of sight is aligned with the calibration target, similar to the z-axis calibration described above, the head pose may be obtained by performing the above operations S810 to S840 or by performing operations S910 to S940. The x-axis coordinate x of the pupil is obtained from the head pose. The theoretical value Xₜᵣᵤₑ of the x-axis coordinate of the pupil is calculated based on the calibration information on the sphere, and then Δx=Xₜᵣᵤₑ−x is calibrated. The data pairs of the M values of x and corresponding deviations Δx are sorted in ascending order of values of x to obtain ordered data pairs: (x₁, Δx₁), (x₂, Δx₂), . . . , (x_{M}. Δx_{M}) Thus, the construction of the x-axis coordinates and corresponding deviations in the deviation field is completed, i.e., the x-axis calibration is completed.

In practical application, after obtaining the x-axis coordinate x_{*} in the user's head pose obtained in operation S940, the deviation Δx_{*} corresponding to x_{*} may be determined based on the x-axis calibration data in the deviation field constructed above through interpolation, same as the interpolation for the z-axis data. Then, the corresponding true coordinate Xₜᵣᵤₑ may be determined. Thus, the correction of the pose in the x-axis direction is completed.

The head pose detected according to embodiments of the present disclosure may be applied to different scenarios.

For example, in a presenting scenario such as a game scenario, a museum exhibit viewing scenario, etc., a virtual capture position may be calculated according to pupil coordinates of left and right eyes in the head pose of the object, and a virtual capture direction may be determined as a head orientation in the head pose. The image to be displayed on a screen may be rendered based on the virtual capture position and the virtual capture direction; and the rendered image may be displayed on the screen. For example, the head pose of the user may be detected in real time based on the above methods by using a monocular camera integrated on the screen. The detected head pose may be used as the pose of the virtual camera (including the virtual capture position and the virtual capture direction) capturing a virtual scene. By transforming the pose of the virtual camera into the screen coordinate system and into the coordinate system of the virtual scene (e.g., a virtual 3D scene), the image to be displayed may be generated based on the pose of the virtual camera and displayed on the screen. This allows the user to see different perspectives of the game scene or view the exhibit from different angles as their head moves. The screen may be a 2D screen or a 3D screen. If the screen is 2D screen, an average of the pupil coordinates of the left and right eyes of the user may be used as the virtual capture position, and an image to be displayed may be generated according to the virtual capture position and displayed on the 2D screen. If the screen is 3D screen, coordinate of the pupil of the left eye may be obtained as a virtual capture position for a left eye image, coordinate of the pupil of the right eye may be obtained as a virtual capture position for a right eye image, a left eye image and a right eye image may be generated as images to be displayed according to the virtual capture positions for the left and right eye images respectively, and the images to be displayed may be displayed on the 3D screen. The displayed content on the screen may be changed in real time according to the current head pose and the 3D pupil coordinates of the user. The monocular camera may be integrated with the screen as a separate module, and the relative relationship between the camera and the screen may be calibrated in use. The head pose estimation based on the monocular camera improves the cost performance of the product.

For another example, as shown in FIG. 15, in a control scenario such as robot control or embodied intelligence, a head pose of a robot may be controlled according to the head pose of the object, an image captured by a vision sensor mounted on the robot may be acquired, and the captured image may be presented to the object. This may remotely control the robot to perform specified actions. Moreover, the vision sensor mounted on the robot may transmit image data in real time, so that the robot may be widely used in dangerous or heavy physical scenarios to replace relevant personnel such as firefighters and miners, thereby reducing the accident rate and staff casualty rate in corresponding scenarios. Human real-time response or experience values may not be replaced by the robot in a short time. Real-time control of the pose of a humanoid robot, especially the head pose (vision is the most important and primary source of external information for humans), based on human actions is beneficial to improve control accuracy. The monocular-based face pose estimation may accurately and efficiently obtain the current head pose of the operator. Compared with other sensors and head pose acquisition devices (e.g., high-precision gyroscopes or motion capture suits), the monocular camera has a lower cost. The pose of the operator is transmitted to the robot in real time so that the robot reproduces the same actions, and the binocular image data returned by the eye sensors may be presented on a 3D display screen, allowing the operator to view the current environment of the robot on the screen in real time, providing an immersive experience. Compared with existing solutions for head pose estimation and 3D pupil coordinate estimation, the monocular camera has lower hardware requirements and lower cost. Moreover, the accuracy and operating speed of the algorithm have been verified to meet the application requirements of the above scenarios.

In some other embodiments, a grating opening and closing sequence may also be calculated according to the pupil coordinates in the head pose of the object; and opening and closing of a grating in a screen may be controlled according to the grating opening and closing sequence, so as to present a 3D viewing effect adapted to the current viewing pose for the user.

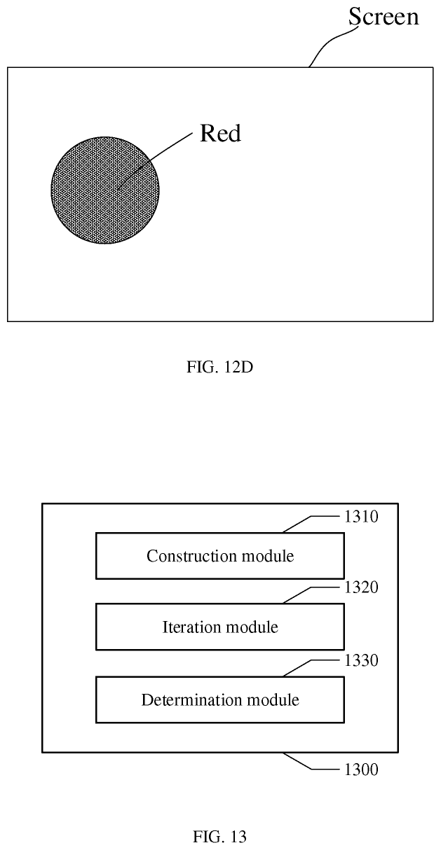

Based on the above-mentioned method of processing the image, the present disclosure further provides an apparatus of processing an image, which will be described in detail below with reference to FIG. 13.

FIG. 13 shows a structural block diagram of an apparatus of processing an image according to the embodiments of the present disclosure.

As shown in FIG. 13, an apparatus 1300 of processing an image in such embodiments includes a construction module 1310, an iteration module 1320, and a determination module 1330.

The construction module 1310 is used to construct an initial three-dimensional face template by using a plurality of sample face images. In an embodiment, the construction module 1310 may be used to perform operation S110 described above, which will not be repeated here.

The iteration module 1320 is used to perform an iterative optimization on the initial three-dimensional face template by using a face image of a target object, so as to obtain a target three-dimensional face template. In an embodiment, the iteration module 1320 may be used to perform operation S120 described above, which will not be repeated here.

The determination module 1330 is used to determine a current face pose of the target object according to a corresponding relationship between a current face image of the target object and the target three-dimensional face template. In an embodiment, the determination module 1330 may be used to perform operation S130 described above, which will not be repeated here.

According to the embodiments of the present disclosure, any number of the construction module 1310, the iteration module 1320 and the determination module 1330 may be combined into one module for implementation, or any one of the modules may be divided into a plurality of modules. Alternatively, at least part of the functions of one or more of these modules may be combined with at least part of the functions of other modules and implemented in one module. According to embodiments of the present disclosure, at least one of the construction module 1310, the iteration module 1320 and the determination module 1330 may be implemented at least partially as a hardware circuit, such as a field programmable gate array (FPGA), a programmable logic array (PLA), a system on a chip, a system on a substrate, a system on a package, an application specific integrated circuit (ASIC), or may be implemented by hardware or firmware in any other reasonable manner of integrating or encapsulating the circuit, or may be implemented by any one of the three implementation modes of software, hardware and firmware or an appropriate combination thereof. Alternatively, at least one of the construction module 1310, the iteration module 1320 and the determination module 1330 may be at least partially implemented as a computer program module that may perform corresponding functions when executed.

The present disclosure further provides an interactive device, including a camera, a processor, a driving circuit, an input/output interface, and a screen. The camera, the processor, the driving circuit, the input/output interface and the screen are electrically connected in sequence

The camera is used to acquire a face image of a target object, and send the face image to the processor.

The processor is used to perform an iterative optimization on an initial three-dimensional face template by using the face image so as to obtain a target three-dimensional face template. Then, the processor may perform a face pose estimation by using the target three-dimensional face template so as to obtain pupil coordinates of the target object. The processor may calculate a grating opening and closing sequence according to the pupil coordinates.

The driving circuit is used to receive the grating opening and closing sequence from the processor, and control the output interface to output the grating opening and closing sequence.

The screen is provided with an array of gratings. The screen is used to control opening and closing of a grating in the array of gratings according to the grating opening and closing sequence.

In the embodiments of the present disclosure, the interactive device is similar to the 3D screen interactive device 220 shown in FIG. 2B of the present disclosure, which will not be repeated here for simplicity.

The methods of processing the image described above with reference to FIGS. 8 to 12D are also applicable to an interactive device having the above structures. In the interactive device, the camera is used to acquire a face image of an object. The processor is electrically connected to the camera and used to: obtain N1 two-dimensional key points from the face image of the object, where the face image includes a plurality of facial regions respectively corresponding to a plurality of mapping models; map the N1 two-dimensional key points of the face image into N2 two-dimensional key points by mapping the two-dimensional key points within each facial region based on the mapping model corresponding to the facial region, where N2 is not equal to N1; perform an iterative optimization on an initial three-dimensional face template by using the N2 two-dimensional key points of the face image, so as to obtain a target three-dimensional face template; perform a face pose estimation by using the target three-dimensional face template, so as to obtain pupil coordinates of the target object; and calculate a grating opening and closing sequence according to the pupil coordinates. A driving circuit is electrically connected to the processor, and the driving circuit is used to control an output interface to output the grating opening and closing sequence. A screen is electrically connected to the driving circuit, and the screen is used to control opening and closing of a grating in the screen according to the grating opening and closing sequence.

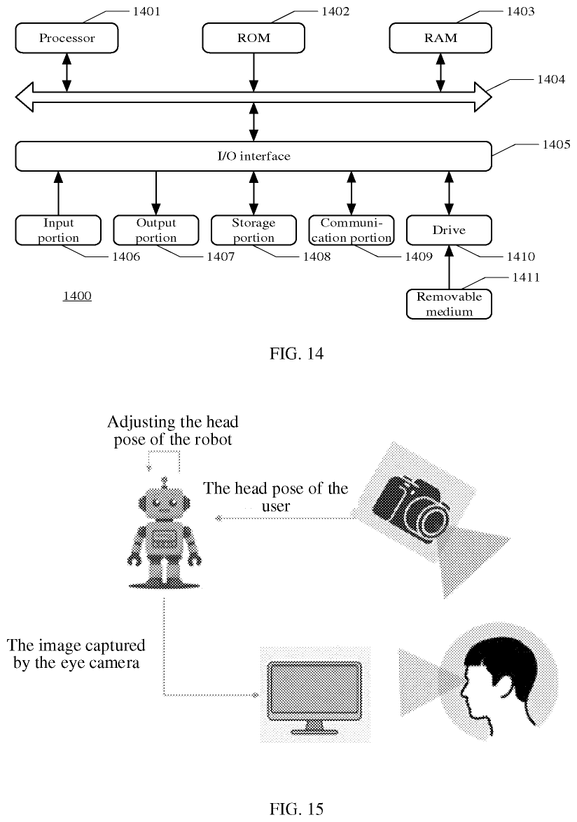

FIG. 14 shows a block diagram of an electronic device suitable for implementing the method of processing the image according to the embodiments of the present disclosure.

As shown in FIG. 14, an electronic device 1400 according to the embodiments of the present disclosure includes a processor 1401, which may execute various appropriate actions and processing according to the program stored in a read only memory (ROM) 1402 or the program loaded into a random access memory (RAM) 1403 from a storage portion 1408. The processor 1401 may, for example, include a general-purpose microprocessor (for example, CPU), an instruction set processor and/or a related chipset and/or a special-purpose microprocessor (for example, an application specific integrated circuit (ASIC)), and the like. The processor 1401 may further include an on-board memory for caching purposes. The processor 1401 may include a single processing unit or multiple processing units for executing different actions of the method flow according to embodiments of the present disclosure.

Various programs and data required for the operation of the electronic device 1400 are stored in the RAM 1403. The processor 1401, the ROM 1402 and the RAM 1403 are connected to each other through a bus 1404. The processor 1401 executes various operations of the method flow according to embodiments of the present disclosure by executing the programs in the ROM 1402 and/or the RAM 1403. It should be noted that the program may also be stored in one or more memories other than the ROM 1402 and the RAM 1403. The processor 1401 may also execute various operations of the method flow according to embodiments of the present disclosure by executing the programs stored in the one or more memories.

According to embodiments of the present disclosure, the electronic device 1400 may further include an input/output (I/O) interface 1405 which is also connected to the bus 1404. The electronic device 1400 may further include one or more of the following components connected to the I/O interface 1405: an input portion 1406 including a keyboard, a mouse, etc.; an output portion 1407 including a cathode ray tube (CRT), a liquid crystal display (LCD), etc. and a speaker, etc.; a storage portion 1408 including a hard disk, etc.; and a communication portion 1409 including a network interface card such as a LAN card, a modem, and the like. The communication portion 1409 performs communication processing via a network such as the Internet. A drive 1410 is also connected to the I/O interface 1405 as required. A removable medium 1411, such as a magnetic disk, an optical disk, a magneto-optical disk, a semiconductor memory, and the like, is installed on the drive 1410 as required, so that the computer program read therefrom is installed into the storage portion 1408 as needed.

The present disclosure further provides a computer-readable storage medium, which may be included in the apparatus/device/system described in the above embodiments; or exist alone without being assembled into the apparatus/device/system. The above-mentioned computer-readable storage medium carries one or more programs that when executed, perform the methods according to embodiments of the present disclosure.

According to embodiments of the present disclosure, the computer-readable storage medium may be a non-transitory computer-readable storage medium, for example, may include but not limited to: a portable computer disk, a hard disk, a random access memory (RAM), a read-only memory (ROM), an erasable programmable read-only memory (EPROM or flash memory), a portable compact disk read-only memory (CD-ROM), an optical storage device, a magnetic storage device, or any suitable combination of the above. In the present disclosure, the computer-readable storage medium may be any tangible medium that contains or stores programs that may be used by or in combination with an instruction execution system, apparatus or device. For example, according to embodiments of the present disclosure, the computer-readable storage medium may include the above-mentioned ROM 1402 and/or RAM 1403 and/or one or more memories other than the ROM 1402 and RAM 1403.

The embodiments of the present disclosure further include a computer program product, which contains a computer program. The computer program contains program code for performing the method provided by the embodiments of the present disclosure. When the computer program product runs on an electronic device, the program code causes the electronic device to implement the method of processing the image provided in the embodiments of the present disclosure.

When the computer program is executed by the processor 1401, the above-mentioned functions defined in the system/apparatus of the embodiments of the present disclosure are performed. According to the embodiments of the present disclosure, the above-described systems, apparatuses, modules, units, etc. may be implemented by computer program modules.

In an embodiment, the computer program may rely on a tangible storage medium such as an optical storage device and a magnetic storage device. In another embodiment, the computer program may also be transmitted and distributed in the form of signals on a network medium, downloaded and installed through the communication portion 1409, and/or installed from the removable medium 1411. The program code contained in the computer program may be transmitted by any suitable medium, including but not limited to a wireless one, a wired one, or any suitable combination of the above.

In such embodiments, the computer program may be downloaded and installed from the network through the communication portion 1409, and/or installed from the removable medium 1411. When the computer program is executed by the processor 1401, the above-mentioned functions defined in the system of the embodiments of the present disclosure are performed. According to the embodiments of the present disclosure, the above-described systems, apparatuses, devices, modules, units, etc. may be implemented by computer program modules.

According to the embodiments of the present disclosure, the program code for executing the computer programs provided by the embodiments of the present disclosure may be written in any combination of one or more programming languages. In particular, these computing programs may be implemented using high-level procedures and/or object-oriented programming languages, and/or assembly/machine languages. Programming languages include, but are not limited to, Java, C++, Python, “C” language or similar programming languages. The program code may be completely executed on the user computing device, partially executed on the user device, partially executed on the remote computing device, or completely executed on the remote computing device or server. In a case of involving a remote computing device, the remote computing device may be connected to a user computing device through any kind of network, including a local area network (LAN) or a wide area networks (WAN), or may be connected to an external computing device (e.g., through the Internet using an Internet service provider).

The flowcharts and block diagrams in the accompanying drawings illustrate the possible architecture, functions, and operations of the system, method, and computer program product according to various embodiments of the present disclosure. In this regard, each block in the flowcharts or block diagrams may represent a part of a module, a program segment, or a code, which part includes one or more executable instructions for implementing the specified logical function. It should be further noted that, in some alternative implementations, the functions noted in the blocks may also occur in a different order from that noted in the accompanying drawings. For example, two blocks shown in succession may actually be executed substantially in parallel, or they may sometimes be executed in a reverse order, depending on the functions involved. It should be further noted that each block in the block diagrams or flowcharts, and the combination of blocks in the block diagrams or flowcharts, may be implemented by a dedicated hardware-based system that performs the specified functions or operations, or may be implemented by a combination of dedicated hardware and computer instructions.

Those skilled in the art may understand that the various embodiments of the present disclosure and/or the features described in the claims may be combined in various ways, even if such combinations are not explicitly described in the present disclosure. In particular, without departing from the spirit and teachings of the present disclosure, the various embodiments of the present disclosure and/or the features described in the claims may be combined in various ways. All these combinations fall within the scope of the present disclosure.

The embodiments of the present disclosure have been described above. However, these embodiments are for illustrative purposes only, and are not intended to limit the scope of the present disclosure. Although the various embodiments have been described separately above, this does not mean that measures in the respective embodiments may not be used in combination advantageously. The scope of the present disclosure is defined by the appended claims and their equivalents. Those skilled in the art may make various substitutions and modifications without departing from the scope of the present disclosure, and these substitutions and modifications should all fall within the scope of the present disclosure.

What is claimed is:

1. A method of processing an image, comprising:
acquiring N1 two-dimensional key points from a face image of an object, wherein the face image comprises a plurality of facial regions, and the plurality of facial regions respectively correspond to a plurality of mapping models;
mapping the N1 two-dimensional key points of the face image into N2 two-dimensional key points by mapping the two-dimensional key points within each facial region based on the mapping model corresponding to the facial region, wherein N2 is not equal to N1;
performing an iterative optimization on an initial three-dimensional face template by using the N2 two-dimensional key points of the face image, so as to obtain a target three-dimensional face template; and
determining a head pose of the object according to a corresponding relationship between the face image and the target three-dimensional face template.

2. The method according to claim 1, further comprising:
acquiring, from each of a plurality of sample face images, N1 two-dimensional key points as first key points and N2 two-dimensional key points as second key points; and
fitting a mapping relationship between the first key points and the second key points within each facial region, so as to obtain the mapping model for the facial region.

3. The method according to claim 2, wherein the fitting the mapping relationship between the first key points and the second key points within each facial region so as to obtain the mapping model for the facial region comprises: for each facial region,
generating a first matrix based on positions of the first key points within the facial region;
generating a second matrix based on positions of the second key points within the facial region; and
calculating a linear mapping matrix from the first matrix to the second matrix, as the mapping model for the facial region.

4. The method according to claim 2, further comprising: after determining the head pose of the object,
determining, from a plurality of reference poses in a pre-constructed deviation field, a reference pose matching the head pose as a target reference pose, wherein the deviation field comprises the plurality of reference poses and a deviation corresponding to each reference pose;
calculating a deviation corresponding to the head pose based on the deviation corresponding to the target reference pose in the deviation field; and
correcting the head pose using the deviation corresponding to the head pose.

5. The method according to claim 4, wherein the determining, from a plurality of reference poses in a pre-constructed deviation field, a reference pose matching the head pose as a target reference pose comprises:
determining, based on the plurality of reference poses, a position interval in which the head pose is located, the position interval being defined by reference poses adjacent in position; and
determining the reference poses that define the position interval, as the target reference poses.

6. The method according to claim 5, wherein the calculating a deviation corresponding to the head pose based on the deviation corresponding to the target reference pose in the deviation field comprises:
performing interpolation calculation on a deviation interval defined by the deviations corresponding to the target reference poses according to a position of the head pose within the position interval, so as to obtain the deviation corresponding to the head pose.

7. The method according to claim 4, further comprising: constructing the deviation field,
wherein constructing the deviation field comprises:
presenting a virtual calibration target having a pose;
in response to detecting that a line of sight of the object is aligned with the virtual calibration target, capturing a face image of the object as a reference image, and performing, on the reference image, the acquiring N1 two-dimensional key points, the mapping, the iterative optimization, and the determining the head pose of the object, so as to obtain a reference pose of the object;
calculating a deviation between the reference pose and the pose of the virtual calibration target;
changing the pose of the virtual calibration target and returning to the presenting the virtual calibration target having the pose, so as to obtain the plurality of reference poses of the object and a deviation between each reference pose and a corresponding pose of the virtual calibration target; and
constructing the deviation field based on the plurality of reference poses and the deviation between each reference pose and the corresponding pose of the virtual calibration target.

8. The method according to claim 7, wherein the calculating the deviation between the reference pose and the pose of the virtual calibration target comprises:
calculating, based on the pose of the virtual calibration target and calibration information on the virtual calibration target, a pupil position of the object when the line of sight of the object is aligned with the virtual calibration target, as a theoretical position;
obtaining a pupil position of the object from the reference pose of the object as a detected position; and
calculating a deviation between the theoretical position and the detected position as the deviation between the reference pose and the pose of the virtual calibration target.

9. The method according to claim 7, wherein the changing the pose of the virtual calibration target comprises at least one of: translating the virtual calibration target along a first direction, or rotating the virtual calibration target along a second direction, wherein the first direction is a depth direction in a screen coordinate system where the virtual calibration target is presented, the second direction is a horizontal direction in the screen coordinate system, and each of the theoretical position and the detected position comprises at least one of a coordinate in the depth direction and a coordinate in the horizontal direction.

10. The method according to claim 7, further comprising:
determining whether the line of sight of the object is aligned with the virtual calibration target according to a confirmation signal provided by the object; or
determining whether the line of sight of the object is aligned with the virtual calibration target by detecting the line of sight of the object.

11. The method according to claim 7, wherein the virtual calibration target is a sphere, and the sphere comprises a first portion having a first color and a second portion having a second color.

12. The method according to claim 1, further comprising constructing an initial three-dimensional face template by using a plurality of sample face images,
wherein the constructing an initial three-dimensional face template comprises:
acquiring a plurality of three-dimensional sample key points from each of the plurality of sample face images;
determining an average three-dimensional face template according to a plurality of three-dimensional sample key points of the plurality of sample face images;
determining a feature matrix of the plurality of sample face images by using the average three-dimensional face template; and
constructing the initial three-dimensional face template according to an iteration parameter, the average three-dimensional face template and the feature matrix.

13. The method according to claim 12, wherein the determining a feature matrix of the plurality of sample face images by using the average three-dimensional face template comprises:
performing a decentralization on the plurality of three-dimensional sample key points of the plurality of sample face images by using the average three-dimensional face template, so as to obtain a covariance matrix;
calculating a plurality of feature values of the covariance matrix and a plurality of feature vectors corresponding to the plurality of feature values;
determining a plurality of valid feature vectors from the plurality of feature vectors according to contribution values of the plurality of feature values to a linear projection in the covariance matrix, wherein a sum of the contribution values of a plurality of feature values corresponding to the plurality of valid feature vectors is greater than a predetermined contribution value; and
constructing the feature matrix according to the plurality of valid feature vectors.

14. The method according to claim 1, further comprising:
calculating a virtual capture position according to pupil coordinates of left and right eyes in the head pose of the object; determining a virtual capture direction as a head orientation in the head pose; rendering an image to be displayed on a screen based on the virtual capture position and the virtual capture direction; and displaying the rendered image on the screen; or
controlling a head pose of a robot according to the head pose of the object; acquiring an image captured by a head-mounted camera of the robot; and presenting the acquired image to the object.

15. The method according to claim 1, further comprising:
calculating a grating opening and closing sequence according to pupil coordinates in the head pose of the object; and
controlling opening and closing of a grating in a screen according to the grating opening and closing sequence.

16. The method according to claim 1, wherein the determining a head pose of the object according to a corresponding relationship between the face image and the target three-dimensional face template comprises:
determining a plurality of predetermined three-dimensional key points of the object from a plurality of three-dimensional key points of the target three-dimensional face template, wherein the plurality of predetermined three-dimensional key points are located in a target coordinate system, and the plurality of predetermined three-dimensional key points correspond to a plurality of specified two-dimensional key points of the face image of the object;
determining a transformation matrix between the camera coordinate system and the target coordinate system according to a corresponding relationship between the pixel coordinate system where the face image from a camera is located and the target coordinate system;
converting the plurality of predetermined three-dimensional key points into a plurality of target three-dimensional key points according to the transformation matrix, wherein the plurality of target three-dimensional key points are located in the camera coordinate system; and
determining the head pose of the object according to the plurality of target three-dimensional key points.

17. The method according to claim 16, wherein the determining a transformation matrix between the camera coordinate system and the target coordinate system according to a corresponding relationship between the pixel coordinate system where the face image from a camera is located and the target coordinate system comprises determining the transformation matrix according to:
$$c [ \begin{matrix}x \\ y \\ z\end{matrix} ] = K \cdot [ \begin{matrix}R & t \\ 0 & 1\end{matrix} ] \cdot [ \begin{matrix}X \\ Y \\ Z \\ 1\end{matrix} ]$$
where c represents a scale of the camera, x and y respectively represent coordinate values of the two-dimensional projection key points on x-axis and y-axis of the pixel coordinate system, X, Y and Z respectively represent coordinate values of the predetermined three-dimensional key points on x-axis, y-axis and z-axis of the target coordinate system, K represents an internal parameter matrix of the camera, and
$$[ \begin{matrix}R & t \\ 0 & 1\end{matrix} ]$$
represents the transformation matrix.

18. An interactive device, comprising:
a camera configured to acquire a face image of an object;
a processor electrically connected to the camera, wherein the processor is configured to:
acquire N1 two-dimensional key points from a face image of an object, wherein the face image comprises a plurality of facial regions, and the plurality of facial regions respectively correspond to a plurality of mapping models;
map the N1 two-dimensional key points of the face image into N2 two-dimensional key points by mapping the two-dimensional key points within each facial region based on the mapping model corresponding to the facial region, wherein N2 is not equal to N1;
perform an iterative optimization on an initial three-dimensional face template by using the N2 two-dimensional key points of the face image, so as to obtain a target three-dimensional face template;
perform a face pose estimation by using the target three-dimensional face template so as to obtain pupil coordinates of the target object; and
calculate a grating opening and closing sequence according to the pupil coordinates;
a driving circuit electrically connected to the processor, wherein the driving circuit is configured to control an output interface to output the grating opening and closing sequence; and
a screen electrically connected to the driving circuit, wherein the screen is configured to control opening and closing of a grating in the screen according to the grating opening and closing sequence.

19. An electronic device, comprising:
one or more processors; and
a memory configured to store one or more programs, wherein the one or more programs, when executed by the one or more processors, are configured to cause the one or more processors to implement the method of claim 1.

20. A computer-readable storage medium having executable instructions therein, wherein the instructions, when executed by a processor, are configured to cause the processor to implement the method of claim 1.
